(19) United States
(12) Patent Application Publication
(10) Pub. No.: US 2026/0178894 A1
(43) Pub. Date: Jun. 25, 2026

(54) THREE-DIMENSIONAL COARSE-PARTICLE RECONFIGURABLE ARRAY CONSTRUCTION SYSTEM AND CONTROL METHOD OF THREE-DIMENSIONAL COARSE-PARTICLE RECONFIGURABLE ARRAY CONSTRUCTION SYSTEM

(71) Applicant: Industrial Technology Research Institute, Hsinchu (TW)

(72) Inventors: Chia-Hsiang Yang, Kinmen County (TW); Xing-Hong Ye, New Taipei City (TW)

(73) Assignee: Industrial Technology Research Institute, Hsinchu (TW)

(21) Appl. No.: 19/001,420

(22) Filed: Dec. 25, 2024

(51) Int. Cl. G06N 3/063; G06N 3/04

(52) U.S. Cl. CPC G06N 3/063; G06N 3/04

(57) ABSTRACT

The present disclosure provides a three-dimensional coarse-grained reconfigurable array architecture system and its control method. The system includes multiple first arrays and multiple second arrays, wherein each first array includes multiple first processing elements, multiple first memory units, and multiple first switches, and each second array includes multiple second processing elements, multiple second memory units, and multiple second switches. The system employs an interleaved stacking arrangement for the first arrays and second arrays, and dynamically manages the activation and deactivation states of various units through a configuration controller to execute neural network model computation tasks. The technical solution of the present disclosure can significantly improve data transmission efficiency, increase resource utilization flexibility, and achieve optimal allocation of hardware resources.

### BACKGROUND

### Technical Field

The present disclosure relates to a processor hardware architecture, particularly to a three-dimensional hardware architecture system and its control method based on a Coarse-Grained Reconfigurable Array (CGRA) processor.

### Description of Related Art

With the rapid development of artificial intelligence technology, especially in the fields of machine learning and deep learning, higher requirements for performance and flexibility have been placed on processor hardware architectures. Traditional processor architectures, such as Central Processing Units (CPU) and Graphics Processing Units (GPU), may encounter performance bottlenecks and power consumption issues when facing large-scale parallel computing and frequent data access.

To address the aforementioned issues, researchers have proposed various Domain-Specific Architectures (DSA) and reconfigurable hardware architectures. Among them, Coarse-Grained Reconfigurable Architecture (CGRA) processors have received extensive attention due to higher flexibility and energy efficiency. CGRA typically consists of a large number of Processing Elements (PE) and interconnection networks, which can dynamically adjust hardware configurations according to the requirements of different applications to achieve efficient parallel computing.

However, current CGRA architectures mostly adopt two-dimensional (2D) mesh topology, where the interconnection method between processing elements is relatively simple, mainly transmitting data in four adjacent directions: up, down, left, and right. This architecture may face issues such as inefficient data access and low utilization rate of processing element when processing applications with complex data dependencies.

### SUMMARY

To solve the aforementioned technical problems, the present disclosure provides a three-dimensional coarse-grained reconfigurable array architecture system and its control method. The architecture of the present disclosure includes alternately stacked computing arrays and storage arrays, achieving more efficient neural network computation through vertical interconnections and flexible resource allocation mechanisms.

One or more embodiments of the present disclosure provide a three-dimensional coarse-grained reconfigurable array architecture system adapted for implementing a neural network model. The three-dimensional coarse-grained reconfigurable array architecture system comprises: a plurality of first arrays, wherein each first array comprises: a plurality of first processing units configured to execute neural network computing tasks of nodes of the neural network model; a plurality of first memory units configured to store data of corresponding neural network computing tasks, wherein in each first array, a number of the plurality of first processing units is greater than a number of the plurality of first memory units; and a plurality of first switches configured to execute corresponding routing tasks, wherein the first switches are not directly connected to each other, wherein the plurality of first processing units, the plurality of first memory units, and the plurality of first switches are distributed on an array plane of the first array; a plurality of second arrays, wherein each second array comprises: a plurality of second processing units configured to execute neural network computing tasks of nodes of a neural network model; a plurality of second memory units configured to store data of corresponding neural network computing tasks, wherein a number of the plurality of second memory units is greater than a number of the plurality of second processing units; and a plurality of second switches configured to execute corresponding routing tasks, wherein the second switches are not directly connected to each other, wherein the plurality of second processing units, the plurality of second memory units, and the plurality of second switches are distributed on an array plane of the second array; an input/output interface configured to receive input data and transmit processing results; a configuration controller electrically connected to the plurality of first arrays and the plurality of second arrays, wherein each first array and each second array are alternately stacked, wherein arrays adjacent to each first array in a vertical direction with respect to the corresponding array plane are the second arrays, wherein arrays adjacent to each second array in a vertical direction with respect to the corresponding array plane are the first arrays. The configuration controller is configured to monitor respective working states of the plurality of first arrays and the plurality of second arrays; according to computational graph information corresponding to the neural network model, dynamically manage activation and deactivation of the plurality of first processing units, the plurality of first memory units, the plurality of first switches, the plurality of second memory units, the plurality of second processing units, and the plurality of second switches, so as to execute a plurality of neural network computing tasks of the neural network model.

One or more embodiments of the present disclosure provide a control method of a three-dimensional coarse-grained reconfigurable array architecture system, wherein the three-dimensional coarse-grained reconfigurable array architecture system is adapted for implementing a neural network model. The method comprises: through a configuration controller, monitoring respective working states of a plurality of first arrays and a plurality of second arrays of the three-dimensional coarse-grained reconfigurable array architecture system, wherein each first array comprises: a plurality of first processing units configured to execute neural network computing tasks of nodes of the neural network model; a plurality of first memory units configured to store data of corresponding neural network computing tasks, wherein in each first array, a number of the plurality of first processing units is greater than a number of the plurality of first memory units; and a plurality of first switches configured to execute corresponding routing tasks, wherein the first switches are not directly connected to each other, wherein the plurality of first processing units, the plurality of first memory units, and the plurality of first switches are distributed on an array plane of the first array; wherein each second array comprises: a plurality of second processing units configured to execute neural network computing tasks of nodes of the neural network model; a plurality of second memory units configured to store data of corresponding neural network computing tasks, wherein a number of the plurality of second memory units is greater than a number of the plurality of second processing units; and a plurality of second switches configured to execute corresponding routing tasks, wherein the second switches are not directly connected to each other, wherein the plurality of second processing units, the plurality of second memory units, and the plurality of second switches are distributed on an array plane of the second array, wherein the configuration controller is electrically connected to the plurality of first arrays and the plurality of second arrays, wherein each first array and each second array are alternately stacked, wherein arrays adjacent to each first array in a vertical direction with respect to the corresponding array plane are the second arrays, wherein arrays adjacent to each second array in a vertical direction with respect to the corresponding array plane are the first arrays; and according to computational graph information corresponding to the neural network model, through the configuration controller dynamically managing activation and deactivation of the plurality of first processing units, the plurality of first memory units, the plurality of first switches, the plurality of second memory units, the plurality of second processing units, and the plurality of second switches, so as to execute a plurality of neural network computing tasks of the neural network model.

Based on the above, the three-dimensional coarse-grained reconfigurable array architecture system and its control method provided by the present disclosure may achieve the following technical effects: (1) through the three-dimensional stacked heterogeneous array architecture, significantly shortening data transmission paths and improving data transmission efficiency; (2) through functional differentiation and alternating stacking configuration of computing arrays and storage arrays, enabling the system to more efficiently allocate computing resources according to the computational characteristics of neural network models; (3) through the dynamic management mechanism of the configuration controller, achieving optimal configuration of processing units, memory units and switches, effectively improving hardware resource utilization.

Several exemplary embodiments accompanied with figures are described in detail below to further describe the disclosure in details.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a block diagram of a three-dimensional coarse-grained reconfigurable array architecture system according to an embodiment of the present disclosure.

FIG. 2 is a block diagram of a configuration controller of the three-dimensional coarse-grained reconfigurable array architecture system according to an embodiment of the present disclosure.

FIG. 3A is a schematic diagram showing a first alternating stacking arrangement of the three-dimensional coarse-grained reconfigurable array architecture system according to an embodiment of the present disclosure.

FIG. 3B is a schematic diagram showing a second alternating stacking arrangement of the three-dimensional coarse-grained reconfigurable array architecture system according to an embodiment of the present disclosure.

FIG. 4A is a schematic diagram showing a first layout of first arrays and second arrays of the three-dimensional coarse-grained reconfigurable array architecture system according to an embodiment of the present disclosure.

FIG. 4B is a schematic diagram showing a second layout of first arrays and second arrays of the three-dimensional coarse-grained reconfigurable array architecture system according to an embodiment of the present disclosure.

FIG. 4C is a schematic diagram showing a third layout of first arrays and second arrays of the three-dimensional coarse-grained reconfigurable array architecture system according to an embodiment of the present disclosure.

FIG. 4D is a schematic diagram showing a fourth layout of first arrays and second arrays of the three-dimensional coarse-grained reconfigurable array architecture system according to an embodiment of the present disclosure.

FIG. 5 is a schematic diagram showing a three-dimensional architecture corresponding to the first layout of first arrays and second arrays according to an embodiment of the present disclosure.

FIG. 6 is a schematic diagram showing a three-dimensional architecture corresponding to the third layout of first arrays and second arrays according to an embodiment of the present disclosure.

FIG. 7 is a flowchart of a control method of the three-dimensional coarse-grained reconfigurable array architecture system according to an embodiment of the present disclosure.

FIG. 8 is a schematic diagram showing acquisition of computational graph information corresponding to a neural network model according to an embodiment of the present disclosure.

FIG. 9 is a schematic diagram showing selection of target task processing units according to transmission paths according to an embodiment of the present disclosure.

FIGS. 10A to 10C are schematic diagrams showing configuration of processing units for executing corresponding neural network computing tasks according to computational graph information according to an embodiment of the present disclosure.

FIGS. 11A to 11D are schematic diagrams showing configuration of processing units for executing corresponding neural network computing tasks according to computational graph information according to another embodiment of the present disclosure.

### DESCRIPTION OF THE EMBODIMENTS

Reference will now be made in detail to the embodiments of the disclosure, examples of which are illustrated in the accompanying drawings. The same reference numbers are used throughout the drawings and description wherever possible to refer to the same or like parts or components.

It should be understood that the terms “system” and “controller” used in the present disclosure may often be used interchangeably. The term “and/or” used in the present disclosure is only for describing relationships between associated objects, which means that four relationships may exist. For example, A and/or B may mean four situations: A, B, A and B, or A or B. Additionally, the character “/” used in the present disclosure generally indicates that the associated objects are in an “or” relationship.

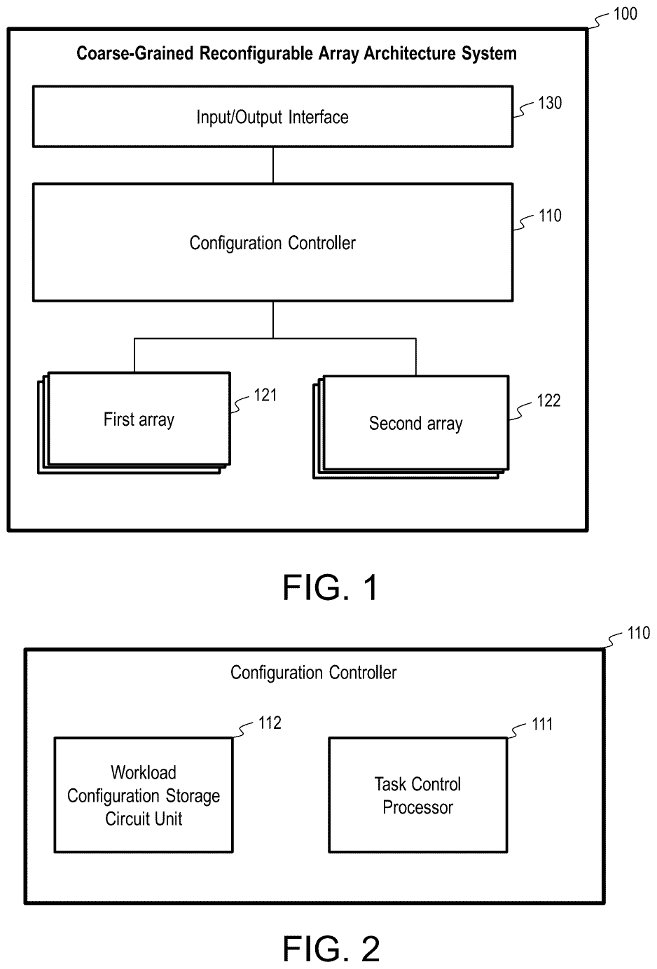

FIG. 1 is a block diagram of a three-dimensional coarse-grained reconfigurable array architecture system according to an embodiment of the present disclosure.

Referring to FIG. 1, in an embodiment, the three-dimensional coarse-grained reconfigurable array architecture system 100 comprises: an input/output interface 130, a configuration controller 110, a plurality of first arrays 121 and a plurality of second arrays 122. The first arrays 121 and the second arrays 122 are alternately stacked to form a three-dimensional structure.

In an embodiment, the three-dimensional coarse-grained reconfigurable array architecture system 100 of the present disclosure may be implemented as the following specific semiconductor devices: a reconfigurable neural network processor particularly suitable for edge computing devices, which may dynamically adjust its internal computing resources to process neural network models of different scales; an intelligent image processor for real-time image recognition and analysis scenarios, which may flexibly configure the usage of processing units and memory units according to processing task requirements; an AI accelerator specifically optimized for deep learning inference tasks, significantly improving data access efficiency through heterogeneous array interleaved stacking design; a programmable tensor processor supporting various matrix operations and vector operations, suitable for both training and inference phases of machine learning models; and an embedded system co-processor serving as a computing auxiliary unit for the main processor, which may be customized for specific application scenarios.

In an embodiment, the three-dimensional coarse-grained reconfigurable array architecture system 100 of the present disclosure may be integrated into the following electronic devices, for example: 1.) Smartphones and wearable devices. Due to the need to support diverse applications such as games, photography, AI inference (image enhancement, voice assistants, etc.) and 5G communication. These devices may add acceleration chips with reconfigurable array architecture to accelerate specific workloads (such as image processing, AI inference) while maintaining low power consumption. 2.) Drones. Unmanned vehicles need to perform tasks of higher complexity, such as navigation control, object tracking, environmental awareness and image processing, and these computing requirements vary with task types. The reconfigurable array architecture system may reconfigure its computing architecture according to task requirements, providing the required computing power while reducing energy consumption.

3.) Industrial automation controllers for real-time processing of large amounts of sensor data and execution of complex control algorithms; 4.) Data center servers, particularly computing servers for large-scale neural network model training and inference; 5.) Medical imaging diagnostic equipment for real-time analysis and diagnosis of high-resolution medical images; and 6.) Advanced Driver-Assistance Systems (ADAS) integrated into vehicle computers for processing real-time data analysis and decision-making from multiple sensors. It should be noted that the above electronic devices are only exemplary in nature, and the present disclosure is not limited thereto; any electronic device that may apply the coarse-grained reconfigurable array architecture system 100 may be suitable for the present disclosure.

In this embodiment, the input/output interface 130 is configured to receive external input data and output computation results. The input data may include parameters of the neural network model, computation instructions, data to be processed, or any data related to the neural network model. The computation results may include single node or overall neural network final output results of neural network computation.

The configuration controller 110 is electrically connected to the input/output interface 130, the plurality of first arrays 121 and the plurality of second arrays 122. The configuration controller 110 is responsible for monitoring respective working states of the plurality of first arrays 121 and the plurality of second arrays 122, and dynamically managing activation and deactivation states of components in each first array 121 and each second array according to computational graph information corresponding to the neural network model.

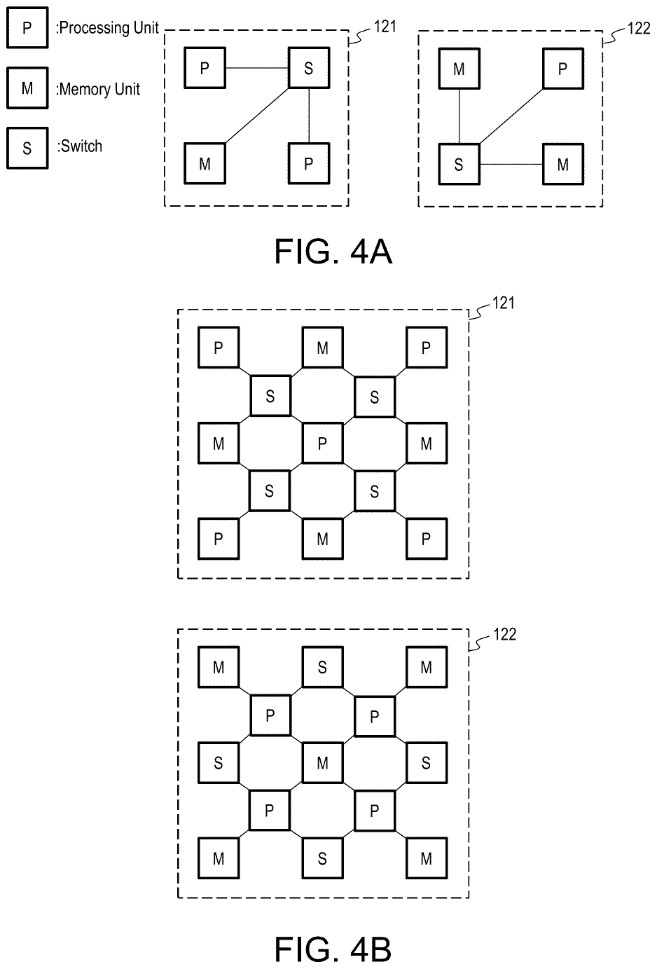

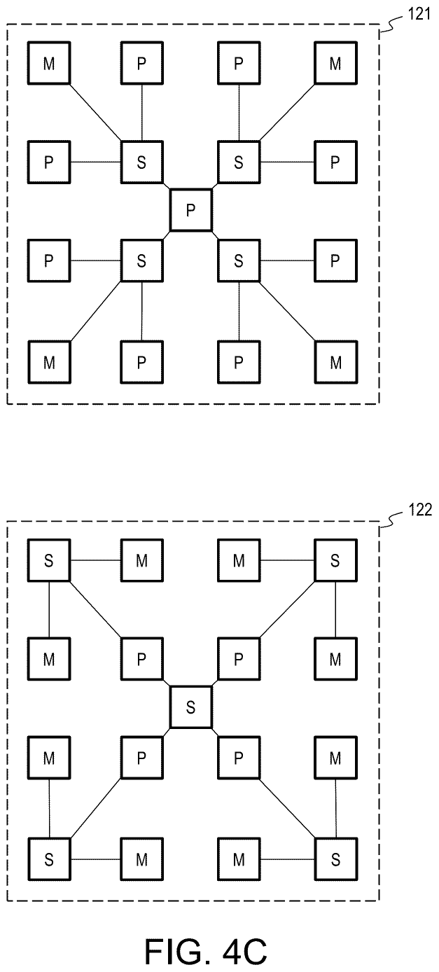

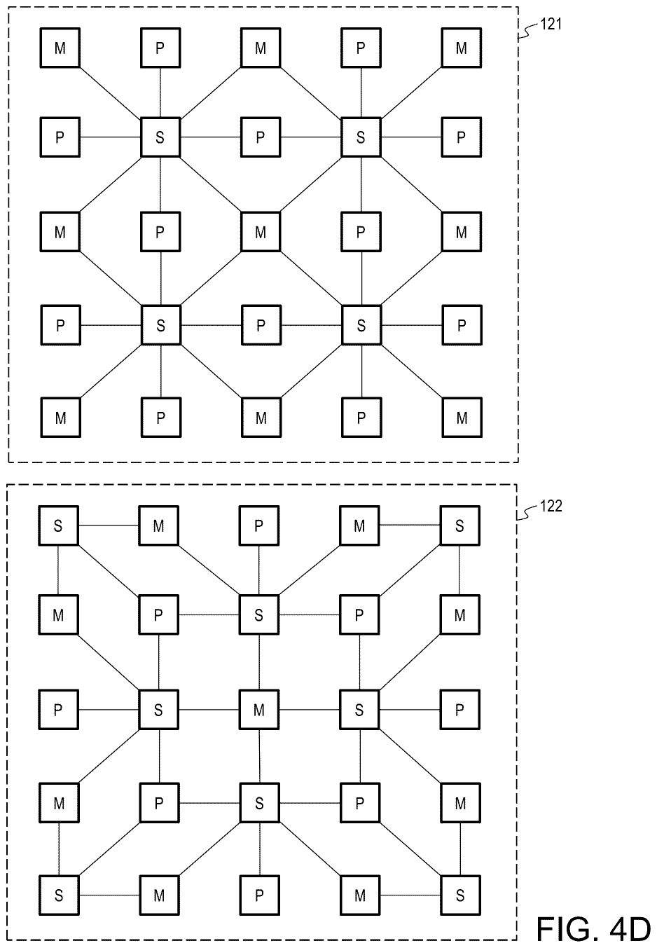

In an embodiment (see FIGS. 4A-4D), each first array 121 comprises a plurality of first processing units, a plurality of first memory units and a plurality of first switches, wherein the plurality of first processing units, the plurality of first memory units and the plurality of first switches are distributed on an array plane of the first array. Specifically, the plurality of first processing units is configured to execute neural network computing tasks of nodes of the neural network model, and the plurality of first memory units is configured to store data of corresponding neural network computing tasks. It is worth noting that in this embodiment, in each first array 121, a number of the plurality of first processing units is greater than a number of the plurality of first memory units, and this design is particularly suitable for processing computation-intensive tasks. Additionally, the plurality of first switches is configured to execute corresponding routing tasks, wherein the first switches are not directly connected to each other.

Correspondingly, in this embodiment (see FIGS. 4A-4D), each second array 122 comprises a plurality of second processing units, a plurality of second memory units and a plurality of second switches, wherein the plurality of second processing units, the plurality of second memory units and the plurality of second switches are distributed on an array plane of the second array. Specifically, the plurality of second processing units is configured to execute neural network computing tasks of nodes of the neural network model, and the plurality of second memory units is configured to store data of corresponding neural network computing tasks. Unlike the first array 121, in the second array 122, a number of the plurality of second memory units is greater than a number of the plurality of second processing units, and this design is particularly suitable for processing tasks requiring large amounts of data storage. Similar to the first array 121, the plurality of second switches is configured to execute corresponding routing tasks, wherein the second switches are not directly connected to each other, so as to optimize data transmission efficiency. In other words, in this embodiment, the first array may also be called a computation-enhanced array with stronger total node computation capability, while the second array may also be called a storage-enhanced array with stronger total data storage capability.

In an embodiment, the first arrays 121 and second arrays 122 employ a vertical interconnection data transmission mechanism. Specifically, first switches of each first array are vertically connected to second processing units or second memory units of adjacent second arrays, while second switches of each second array are vertically connected to first processing units or first memory units of adjacent first arrays.

In this embodiment, in each first array 121, each first processing unit and each first memory unit are not directly connected to each other. Instead, each first processing unit and each first memory unit are connected through at least one intermediate first switch.

Similarly, in each second array 122, each second processing unit and each second memory unit are also not directly connected to each other. Each second processing unit and each second memory unit are connected through at least one intermediate second switch. This design further enhances the data transmission management capability within arrays, making data transmission paths more diverse.

In the vertical direction, the present disclosure introduces a cross-layer vertical connection mechanism. First switches of each first array 121 are vertically connected to second processing units or second memory units of adjacent second arrays 122. This vertical connection allows first data of the first array 121 to be directly transmitted through the first switches to second processing units or second memory units of adjacent second arrays 122, achieving more efficient cross-layer transmission.

Similarly, second switches of each second array 122 are vertically connected to first memory units or first processing units of adjacent first arrays 121. Through this vertical connection, second data of the second array 122 may be directly transmitted through the second switches to first processing units or first memory units of adjacent first arrays 121, completing cross-layer data exchange.

It is worth mentioning that in this embodiment, during cross-layer data transmission, switches always serve as the initiating end, actively sending data to processing units or memory units in adjacent layers.

In an embodiment, the processing units (including first processing units and second processing units) may be implemented using reconfigurable processing units. Specifically, these processing units may dynamically adjust their computation modes according to different computation requirements. For example, when executing matrix multiplication operations, reconfigurable processing units may be configured as systolic array architecture; when executing convolution operations, they may be reconfigured as two-dimensional computing array architecture. Through this flexible configuration method, processing units are particularly suitable for handling different types of computation requirements in deep learning, including high-dimensional matrix multiplication, convolution operations, and vector operations.

In this embodiment, the memory units (including first memory units and second memory units) may be implemented using Static Random-Access Memory. This memory has high-speed read-write characteristics, suitable for storing data of neural network computing tasks, including weight parameters, computation intermediate results, and computation input data. Furthermore, memory units may be divided into multiple memory banks according to data access patterns, where each memory bank may perform read-write operations independently. This design may effectively improve data access parallelism.

In another embodiment, the switches (including first switches and second switches) adopt a distributed routing architecture, comprising multiple routing nodes. Each routing node has data buffering capability, capable of temporarily storing data packets to be forwarded and selecting optimal transmission paths based on destination information. Through this distributed routing architecture, the system may achieve more flexible data transmission scheduling and reduce data transmission conflicts. The switches may also implement a multi-layer crossbar architecture, capable of supporting transmission requirements of multiple data flows simultaneously. This architecture includes multiple crossbar switch layers, with each layer responsible for data transmission in specific directions. Through proper configuration of crossbar connection states, the system may establish multiple independent data transmission channels, improving the parallelism of data transmission.

In one embodiment, the switches may handle data transmission according to routing tasks configured by the configuration controller 110. Specifically, the routing tasks include: identification information of destination processing units or memory units, priority level information of data transmission, packet size information of the data, and relay point information of data transmission paths. The switches establish corresponding data transmission channels based on this routing information and ensure that the data is transmitted according to the specified transmission paths.

FIG. 2 is a block diagram of a configuration controller of the three-dimensional coarse-grained reconfigurable array architecture system according to an embodiment of the present disclosure.

Referring to FIG. 2, in this embodiment, the configuration controller 110 includes a workload configuration storage circuit unit 112 and a task control processor 111.

In this embodiment, the configuration controller 110 controls data transmission between components through the following mechanism. First, the configuration controller 110 determines the data dependencies between nodes based on the computational graph information stored in the workload configuration storage circuit unit 112. For example, the task control processor 111 of the configuration controller 110 may establish a data transmission schedule, which includes: timing arrangements for data transmission, switch configuration sequences for transmission paths, and access timings for each memory unit.

Specifically, when executing a specific node computation task, the configuration controller 110 first sends routing configuration instructions to the corresponding switches to set their routing states. These routing states determine the forwarding directions of data packets within the switch network. At the same time, the configuration controller 110 also sends read or write instructions to related memory units to control the timing of data access. Once the data transmission path is established, the configuration controller 110 then activates the corresponding processing units to begin executing the specified computation tasks.

During the data transmission process, the configuration controller 110 continuously monitors the operational states of each switch, including the current data transmission progress and whether data transmission conflicts occur. If potential transmission conflicts are detected, the configuration controller 110 can immediately adjust the priority of data transmission or re-plan the transmission paths to ensure the reliability and efficiency of data transmission.

In one embodiment, the processing units and memory units, in addition to performing their primary computation and storage functions, are also configured to have data forwarding capabilities. Specifically, when a processing unit or memory unit receives data not intended for itself, it can autonomously determine the destination information of the data and directly forward the data to the next target unit without requiring intermediate processing by a switch. For example, when forwarding data, the processing unit or memory unit reads the destination tag included in the data. If the destination tag indicates that the data is not intended for itself, the unit selects the most appropriate transmission direction based on routing information preconfigured by the configuration controller and forwards the data completely to the next node. During this transmission process, the processing unit or memory unit is only responsible for data forwarding and does not perform any modifications or processing on the data content. Through this direct forwarding mechanism of the processing units and memory units, the system can establish more direct data transmission paths.

Through the above control mechanism, the configuration controller 110 ensures that the data transmission in the system meets the dependency requirements of computation tasks while achieving high utilization efficiency of component resources. Additionally, the dynamic adjustment feature of this control mechanism enables the system to adapt to neural network computation needs of different scales and types.

It is noteworthy that while the processing units, memory units, and switches perform the same functions in the first array 121 and the second array 122, their quantity configurations differ in the two arrays. In the first array 121, the number of processing units is greater than the number of memory units, whereas in the second array 122, the number of memory units is greater than the number of processing units. Through this differentiated quantity configuration, the system achieves an optimal balance between computational performance and memory access efficiency during deep learning computations. At the same time, by dynamically managing resources through the configuration controller 110, the system realizes optimization of resource utilization.

In this embodiment, the workload configuration storage circuit unit 112 is used to store computational graph information of the neural network model.

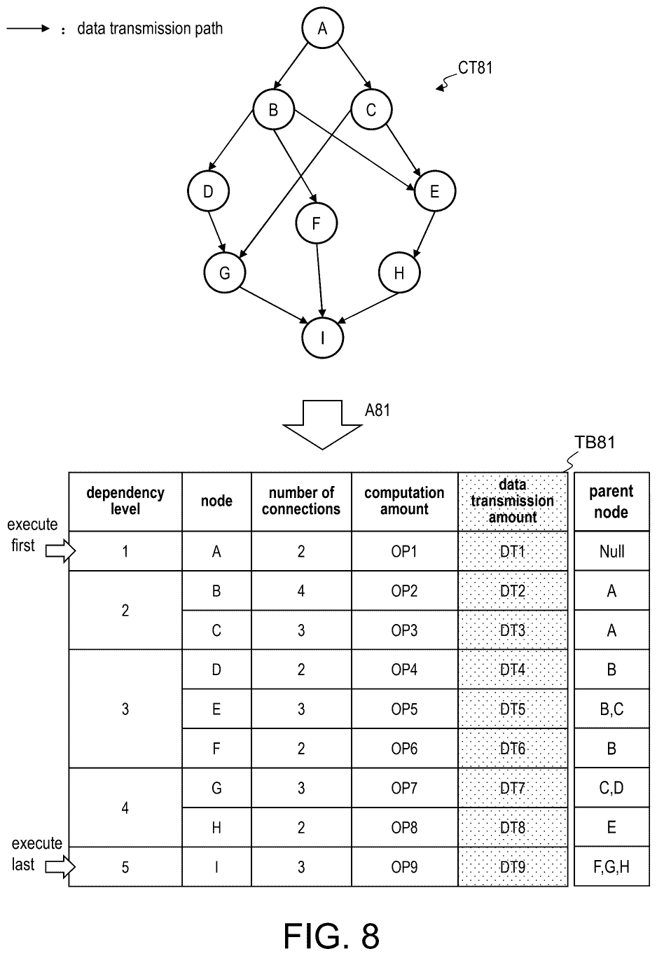

Specifically, in one embodiment, the computational graph information includes: (1) dependency level information of respective nodes, configured to indicate the execution order of the nodes in the neural network model. This dependency level information allows nodes at the same execution level to be executed in parallel, while nodes at different execution levels are executed sequentially; (2) connection number information between the nodes, configured to indicate the total number of adjacent nodes connected to each node; (3) data transmission amount information between the nodes, configured to indicate the data size on the transmission paths; and (4) computation amount information of respective nodes, configured to indicate the computation amount of the node computations performed by each node. In another embodiment, the computational graph information may also include information about the parent node of each node. The details of obtaining the computational graph information are illustrated using FIG. 8 below.

In one embodiment, the task control processor 111 dynamically manages the activation and deactivation statuses of the plurality of first processing units, the plurality of first memory units, the plurality of first switches, the plurality of second memory units, the plurality of second processing units, and the plurality of second switches based on the computational graph information, so as to execute a plurality of neural network computing tasks of the neural network model.

In one embodiment, the task control processor 111 first determines the execution order of nodes based on the dependency level information. It then selects appropriate processing unit configurations according to the connection number information (ensuring that the number of switches connected to the selected processing units matches the connection number of the corresponding nodes). Subsequently, it plans data transmission paths according to the data transmission amount information and, finally, allocates computational resources based on the computation amount information and the computational capabilities of each processing unit, thereby achieving optimal configuration of computational resources.

In one embodiment, the configuration controller 110 may be implemented using Application-Specific Integrated Circuit (ASIC), Field-Programmable Gate Array (FPGA), or Programmable Logic Device (PLD). These implementations have characteristics of high performance and low latency, making them particularly suitable for real-time computation resource allocation scenarios.

In another embodiment, the workload configuration storage circuit unit 112 may be implemented using Static Random-Access Memory (SRAM), Dynamic Random-Access Memory (DRAM), or Flash Memory. When selecting the appropriate memory type, factors such as access speed, power consumption, and cost need to be considered.

In yet another embodiment, the task control processor 111 may be implemented using processor cores based on Reduced Instruction Set Computing (RISC) architecture or Very Long Instruction Word (VLIW) architecture. These processor architectures are characterized by high instruction execution efficiency and low power consumption, making them suitable for real-time scheduling of computational resources.

In this embodiment, data transmission paths can be divided into two types: (1) coplanar paths: transmission paths when idle processing units and preceding processing units are located on the same array plane; and (2) non-coplanar paths: transmission paths when idle processing units and preceding processing units are located on different array planes.

The system (e.g., the task control processor 111) may prioritize transmission paths with a smaller total number of components. Specifically, when the total number of components included in the shortest non-coplanar path is less than that in the shortest coplanar path, the system selects a specific idle processing unit corresponding to the shortest non-coplanar path as the target processing unit. This architecture offers better non-coplanar transmission paths compared to traditional planar paths, enhancing data transmission speed and improving the overall efficiency of neural network computing tasks.

In one embodiment, the task control processor 111, for example, may perform the following task scheduling.

Task analysis phase: Select task nodes to be configured according to the dependency level information and in the order of each execution level (dependency level) to begin executing the corresponding neural network computing tasks; ensure that processing units assigned to the same task node can execute the corresponding node computations in parallel; and sort a plurality of neural network computing tasks according to the dependency level information.

Resource allocation phase: Evaluate the computation amount information of each target task node and the computational capability of each idle processing unit; determine whether the idle processing units are sufficient to be assigned to the target task nodes, then select and activate appropriate target processing units according to computation requirements and transmission paths (e.g., the shortest transmission paths).

Dynamic adjustment phase: Monitor the working state of each processing unit; when a processing unit completes a node computation, select a memory unit with the shortest transmission path to store the computation result; reset the completed processing unit as a new idle processing unit; continuously monitor and adjust until all task nodes are configured. In one embodiment, when a processing unit transitions from a busy state to an idle processing unit, the configuration controller 110 determines the power management state of the idle processing unit based on the current system workload. If it is predicted that the processing unit may be reassigned soon, it is set to standby mode to ensure a quick transition back to the operational state; if it is predicted that the processing unit will not be used for a longer period, it may be set to sleep mode or even deep shutdown mode to reduce overall system power consumption. This dynamic power management mechanism effectively balances system performance and energy efficiency. In more detail, in one embodiment, the first state is standby mode, where the system continues to supply clock signals and power and maintains basic state information of the processing unit so that it can quickly enter the operational state, but consumes a moderate level of power. The second state is sleep mode, in which the clock supply is turned off and core voltage is reduced, retaining only essential configuration information; although it consumes less power, it requires a longer wake-up time. The third state is deep shutdown mode, where the power supply is completely cut off, and all state information is cleared, achieving the lowest power consumption but requiring the longest restart time, making it particularly suitable for processing units expected to remain unused for a long period. When determining the power state of a processing unit, the configuration controller 110 considers multiple factors, including the current workload forecast, the system's power consumption budget, the location of the processing unit (to consider cooling effects), and the wake-up time required for each state, to achieve the optimal balance between performance and power consumption. The term “activating” a specific processing unit refers to setting the processing unit to a busy/working state to execute the corresponding node computation; the term “deactivating” a specific processing unit refers to setting the processing unit from a busy/working state to an “inactive” state or to standby, sleep, or deep shutdown mode to save power at varying levels.

Resource optimization phase: Configure processing units based on the connection number information of nodes; ensure that target processing units with a higher number of connections have more switch connections; dynamically adjust data transmission paths to minimize transmission latency.

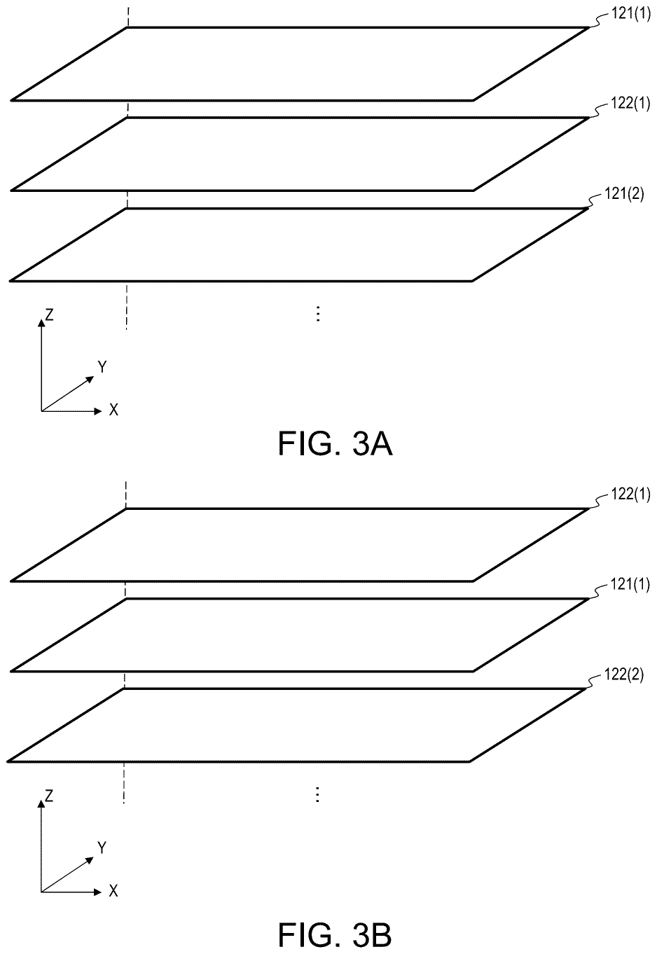

FIG. 3A is a schematic diagram showing a first alternating stacking arrangement of the three-dimensional coarse-grained reconfigurable array architecture system according to an embodiment of the present disclosure. FIG. 3B is a schematic diagram showing a second alternating stacking arrangement of the three-dimensional coarse-grained reconfigurable array architecture system according to an embodiment of the present disclosure.

Referring to FIG. 3A, in one embodiment, the three-dimensional coarse-grained reconfigurable array architecture system adopts the first interleaved stacking configuration for arranging its array structure. In a three-dimensional coordinate system (X, Y, Z), the first array 121(1) is located at the topmost layer, the second array 122(1) is immediately below it, and the first array 121(2) is below the second array 122(1). Each array is parallel to the XY plane and stacked along the Z-axis.

Referring to FIG. 3B, in another embodiment, the system adopts the second interleaved stacking configuration. In this configuration, the second array 122(1) is at the topmost layer, the first array 121(1) is below it, and the second array 122(2) is below the first array 121(1). This arrangement ensures that adjacent layers always maintain the interleaved configuration of the first array 121 and the second array 122.

In this embodiment, data transmission paths between adjacent arrays are established through vertical interconnection structures. When data needs to be transmitted between arrays at different levels, it can be directly transferred through vertical paths without requiring multiple forwarding operations within the same layer, thereby improving data transmission efficiency and operational timeliness.

The main difference between these two interleaved stacking configurations lies in the type of array selected for the topmost layer. The configuration controller 110 may select an appropriate stacking configuration for the system architecture based on the characteristics of the computation tasks.

FIG. 4A is a schematic diagram showing a first layout of first arrays and second arrays of the three-dimensional coarse-grained reconfigurable array architecture system according to an embodiment of the present disclosure.

Referring to FIG. 4A, in one embodiment, the three-dimensional coarse-grained reconfigurable array architecture system includes the first array 121 and the second array 122, where the units are arranged and interconnected in specific ways.

Specifically, the first array 121 adopts a four-unit configuration, including two processing units (P), one memory unit (M), and one switch (S). The two processing units are located at the top-left and bottom-right corners of the array, the memory unit is at the bottom-left corner, and the switch is at the top-right corner. The switch (S) forms a straight-line connection with the processing unit (P) on its left and the processing unit (P) below it, and it forms a diagonal connection with the memory unit (M) at the bottom-left corner.

In the second array 122, the same four-unit configuration is adopted, including one processing unit (P), two memory units (M), and one switch (S). The memory units are located at the top-left and bottom-right corners, the processing unit is at the top-right corner, and the switch is at the bottom-left corner. The switch (S) forms a straight-line connection with the memory unit (M) on its right and the processing unit (P) above it, and it forms a diagonal connection with the processing unit (P) at the top-right corner.

This layout design ensures that each switch (S) is connected to three other units, forming a branch structure. These connections include two straight-line connections and one diagonal connection, which provide fixed and predictable characteristics for the data transmission paths.

FIG. 4B is a schematic diagram showing a second layout of first arrays and second arrays of the three-dimensional coarse-grained reconfigurable array architecture system according to an embodiment of the present disclosure.

Referring to FIG. 4B, in one embodiment, the first array 121 and the second array 122 in the three-dimensional coarse-grained reconfigurable array architecture system adopt an extended nine-unit configuration (3×3 matrix units with an additional four inserted units), also known as the odd array configuration.

In the first array 121, four processing units (P) are located at the top-left, top-right, bottom-left, and bottom-right corners. Four memory units (M) are located at the top-center, left-center, right-center, and bottom-center positions. Four switches (S) are arranged in a cross configuration in the central region, with an additional processing unit (P) placed at the center. Each switch (S) connects with two adjacent processing units (P) and two memory units (M). This configuration ensures that each switch (S) is connected to four adjacent units, forming a mesh topology. The central processing unit (P) connects with four switches(S) in a cross pattern.

The placement of components in the second array 122 follows a similar configuration, but the types of components at each position differ from those in the first array 121. Specifically, four memory units (M) are located at the corners of the array, and four processing units (P) are arranged around a central memory unit (M). Four switches (S) are located at the top-center, left-center, right-center, and bottom-center positions. Each switch (S) connects with two adjacent processing units (P) and two memory units (M). The central memory unit (M) connects with four processing units (P) in a cross pattern.

In one embodiment, the three-dimensional coarse-grained reconfigurable array architecture system adopts the odd array configuration, where adjacent layers are storage arrays (e.g., the second array) and processing arrays (e.g., the first array). The switches(S), processing units (P), and memory units (M) in each array are interconnected based on specific rules.

In this embodiment, each switch (S) is connected to at least one processing unit (P) and one memory unit (M). Specifically, the processing units (P) and memory units (M) connected to the switch (S) are arranged in an interleaved manner, forming a uniformly distributed connection architecture.

Referring to the design features of the storage arrays, the number of memory units (M) connected to each switch(S) is greater than the number of processing units (P). Moreover, through the following rules, the layout of the storage arrays can be transformed into a data array: switches (S) are replaced with memory units (M), memory units (M) are replaced with processing units (P), and processing units (P) are replaced with switches (S).

With respect to the processing arrays, the number of memory units (M) connected to each switch (S) does not exceed the number of processing units (P). This connection configuration makes the processing arrays particularly suitable for executing computation-intensive tasks, while the storage arrays are better suited for scenarios requiring large-scale data storage.

FIG. 4C is a schematic diagram showing a third layout of first arrays and second arrays of the three-dimensional coarse-grained reconfigurable array architecture system according to an embodiment of the present disclosure.

Referring to FIG. 4C, in one embodiment, the first array 121 and the second array 122 in the three-dimensional coarse-grained reconfigurable array architecture system adopt a center-expanded architecture configuration. This configuration is based on a 4×4 matrix array structure with additional components added to the center.

The configuration of the first array 121 is as follows:

Matrix boundary configuration: Four processing units (P) are located at the middle positions on the left and right sides, four memory units (M) are located at the four corners, and four switches(S) are located at the top, bottom, left, and right central points.

Center configuration: An additional processing unit (P) is placed at the exact center of the array.

Connection architecture: Each switch(S) is connected to two processing units (P) and one memory unit (M), while the central processing unit (P) forms cross-connections with four switches (S).

The configuration of the second array 122 is as follows:

Matrix boundary configuration: Four memory units (M) are located at the middle positions on the top and bottom sides, four switches(S) are located at the four corners, and four processing units (P) are located at the top, bottom, left, and right central points.

Center configuration: An additional switch(S) is placed at the exact center of the array.

Connection architecture: Each corner switch(S) is connected to one processing unit (P) and two memory units (M), while the central switch(S) forms cross-connections with four processing units (P).

This configuration combines the boundary connections of the original 4×4 matrix structure with radial center connections, providing more options for data transmission paths while maintaining a regular connection structure. Notably, in one embodiment, the central processing unit of the first array, which is connected to the most switches, can have its computational capability enhanced, such as being N times greater than other processing units (where N>1), to improve the efficiency of processing neural network computing tasks.

Additionally, other features of this layout include:

The two computing units in the peripheral position of the first array will be adjacent, but not interconnected; the two memory units in the peripheral position of the second array will be adjacent, but not interconnected.

FIG. 4D is a schematic diagram showing a fourth layout of first arrays and second arrays of the three-dimensional coarse-grained reconfigurable array architecture system according to an embodiment of the present disclosure.

Referring to FIG. 4D, in one embodiment, the first array 121 and the second array 122 in the three-dimensional coarse-grained reconfigurable array architecture system adopt an extended layout configuration. This configuration extends the basic unit layout (the first layout) shown in FIG. 4A.

The layout configuration of the first array 121 includes: Four groups of switches (S) arranged in a matrix, forming a 2×2 switching network architecture. Each switching network architecture (comprising 2×2 units) has a central switch (S) that connects to eight surrounding units, including four processing units (P) and four memory units (M). Specifically, the processing units (P) are connected to the switches (S) through straight-line connections, while the memory units (M) are connected to the switches (S) through diagonal connections. Adjacent switches(S) are connected through processing units (P), forming horizontal and vertical data transmission channels.

The second array 122 implements a similar extended layout. Its configuration includes:

A storage unit (M) is disposed in the center, surrounded by four switches (S). Each switch (S) forms straight-line connections with three processing units (P) and diagonal connections with two memory units (M). Additionally, switches (S) are placed at the four corners to connect with adjacent memory units (M). These switches (S) are interconnected through the central memory unit (M) and peripheral processing units (P), forming a complete data transmission network.

This extended layout retains the connection characteristics of the basic unit layout while expanding the system's computational and storage capacity by increasing the number of units.

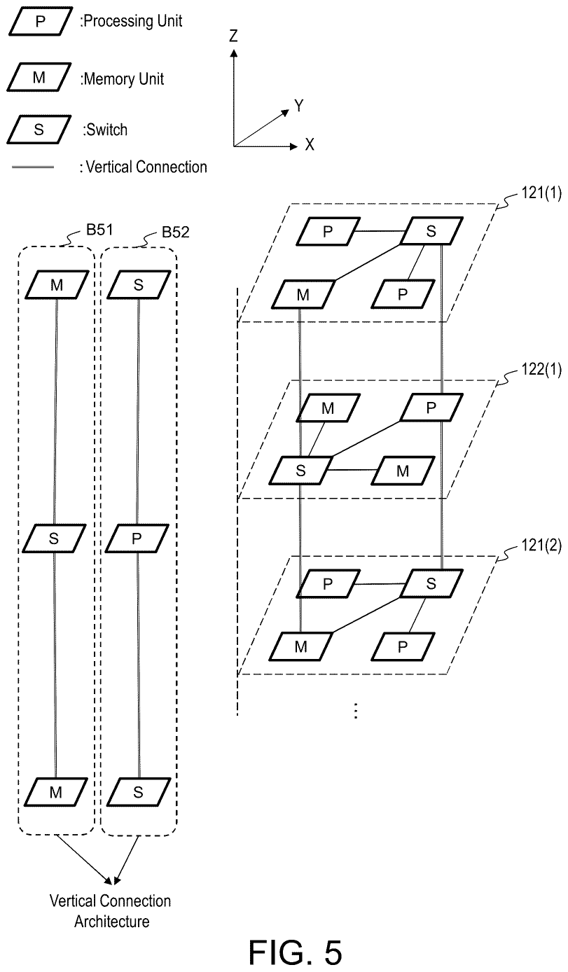

FIG. 5 is a schematic diagram showing a three-dimensional architecture corresponding to the first layout of first arrays and second arrays according to an embodiment of the present disclosure.

Referring to FIG. 5, in one embodiment, the three-dimensional coarse-grained reconfigurable array architecture system adopts a three-dimensional stacking architecture based on the first layout shown in FIG. 4A. The system includes interleaved stacks of the first array 121 and the second array 122, with vertical interconnection structures B51 and B52 enabling cross-layer data transmission.

The first array 121 and the second array 122 maintain their respective planar layout characteristics in the XY plane. In the first array 121(1), a switch(S) is located at the top-right, two processing units (P) are located on the left and below the switch, and a memory unit (M) is located at the bottom-left. Similarly, the first array 121(2) retains the same planar layout. In the second array 122(1), a switch(S) is located at the bottom-left, two memory units (M) are on the right and above the switch, and a processing unit (P) is at the top-right.

In the Z-axis direction, the system implements two types of vertical interconnection structures, for example:
(1) Vertical interconnection structure B51: Comprising an upper memory unit (M) connected directly to a lower switch(S) through vertical interconnects, which in turn connects to another lower memory unit (M). In multiple stacked arrays, the components at the bottom-left exhibit a vertical interconnection pattern of M-S-M-S . . . .
(2) Vertical interconnection structure B52: Comprising an upper switch(S) connected directly to a lower processing unit (P) through vertical interconnects, which in turn connects to another lower switch(S). In multiple stacked arrays, the components at the bottom-left exhibit a vertical interconnection pattern of S-P-S-P . . .

These vertical interconnection structures establish direct data transmission paths between adjacent arrays. Specifically, when a switch(S) in the first array 121(1) needs to communicate with a processing unit (P) in the second array 122(1), the data can be transmitted directly through the vertical interconnection structure B52 without multiple forwarding operations in the horizontal direction. Similarly, when data transmission is required between memory units (M) at different levels, it can be accomplished directly through the vertical interconnection structure B51.

In the overall architecture, adjacent first arrays 121 and second arrays 122 form complementary functional pairs. Through vertical interconnection structures B51 and B52, the system achieves cross-layer data transmission while preserving the planar layout characteristics of each array. This three-dimensional stacking architecture not only retains the connection characteristics of the original planar layout but also provides additional data transmission paths through vertical interconnection structures, thereby enhancing the system's data transmission efficiency.

It is worth mentioning that in this embodiment, when an array performs cross-layer transmission, it first establishes the cross-layer transmission path through the switch in the array. The routing tasks ensure the correctness of the data transmission paths.

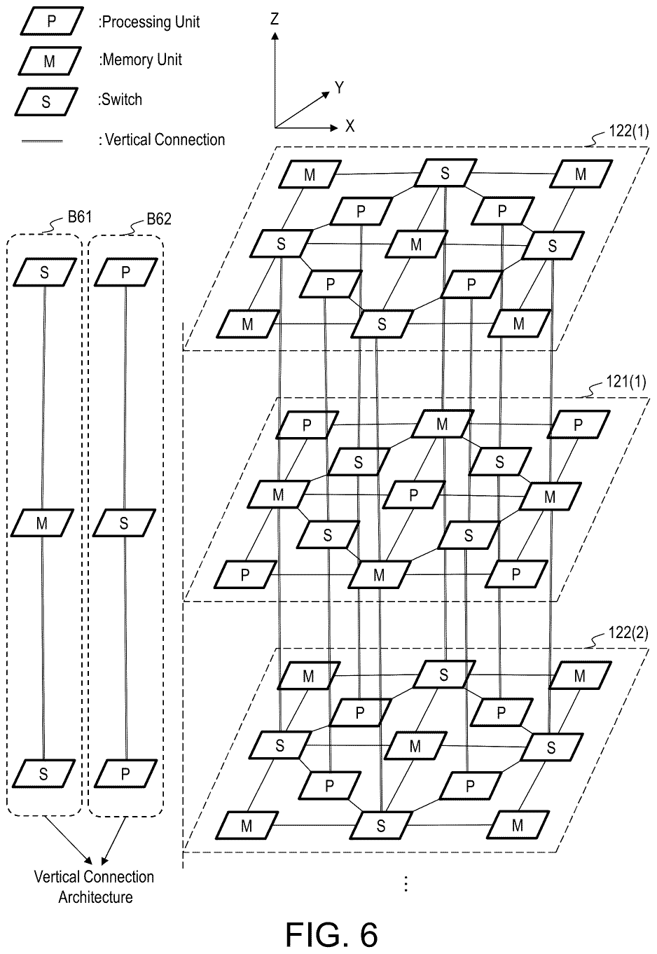

FIG. 6 is a schematic diagram showing a three-dimensional architecture corresponding to the third layout of first arrays and second arrays according to an embodiment of the present disclosure.

Referring to FIG. 6, in the embodiment shown, the vertical interconnection structure exhibits two interleaved arrangements:
(1) Vertical interconnection structure B61: An upper memory unit (M) is connected to a lower processing unit (P) through vertical interconnects, which in turn is connected to another lower memory unit (M). In stacked arrays, vertical interconnection structure B61 forms an interleaved pattern of M-P-M-P . . . .
(2) Vertical interconnection structure B62: An upper switch (S) is connected to a lower memory unit (M) through vertical interconnects, which in turn is connected to another lower switch (S). In stacked arrays, vertical interconnection structure B62 forms an interleaved pattern of S-M-S-M . . . .

The stacking structure shown in FIG. 6 achieves interleaved arrangements of processing units (P), memory units (M), and switches (S) in the vertical direction. Adjacent layers are directly connected through vertical interconnection structures B61 and B62, forming a compact three-dimensional network.

During data transmission, when the first arrays 121(1), 121(2) need to transmit data to the second array 122, cross-layer transmission can be achieved directly through the vertical interconnection structure B61. Similarly, when the second arrays 122(1), 122(2) need to transmit data between different layers, this can also be accomplished directly through the vertical interconnection structure B61.

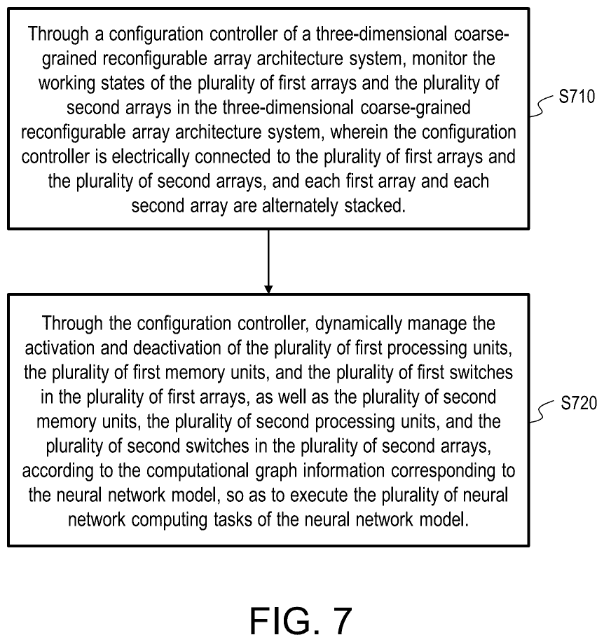

FIG. 7 is a flowchart of a control method of the three-dimensional coarse-grained reconfigurable array architecture system according to an embodiment of the present disclosure.

Referring to FIG. 7, the present disclosure provides a control method for a three-dimensional coarse-grained reconfigurable array architecture system. The method includes the following steps:

Step S710: Monitoring the respective working states of multiple first arrays and multiple second arrays in the three-dimensional coarse-grained reconfigurable array architecture system via the configuration controller. Each first array includes multiple first processing units, multiple first memory units, and multiple first switches, while each second array includes multiple second processing units, multiple second memory units, and multiple second switches.

Specifically, the configuration controller 110 continuously tracks the utilization of processing units, memory units, and switches within each array in real time. In one embodiment, the working states include idle, computing, accessing, active, and completed node computation. For memory units, the working state may further include the data/information recorded in the memory unit. By monitoring their working states, the configuration controller 110 can understand the current allocation of system resources and the storage status of data, providing a basis for subsequent dynamic configuration management.

Step S720: The configuration controller 110 dynamically manages the activation and deactivation of multiple first processing units, multiple first memory units, multiple first switches, multiple second memory units, multiple second processing units, and multiple second switches according to the computational graph information corresponding to the neural network model, so as to execute multiple neural network computing tasks of the neural network model.

In this step, the configuration controller 110 schedules various hardware resources in the system based on the structure and computation sequence of the neural network model. It determines whether to activate or deactivate specific processing units, memory units, and switches, ensuring that neural network computing tasks are executed in the intended order of the neural network model. Additionally, by configuring the routing tasks of the switches, the cross-layer data transmission can proceed smoothly.

FIG. 8 is a schematic diagram showing acquisition of computational graph information corresponding to a neural network model according to an embodiment of the present disclosure.

Referring to FIG. 8, in one embodiment, the system generates corresponding data transmission paths CT81 and computational graph information TB81 based on known architecture data and various parameters of the neural network model. The data transmission paths CT81 are presented in the form of a directed graph, where the arrows between nodes indicate the direction of data flow and express the data dependency relationships between nodes.

In this embodiment, the nodes A to I in the graph represent computation nodes in the neural network model. Each arrow represents a data transmission path, indicating the direction of computation results. For example, the computation result of node A needs to be transmitted to nodes B and C, indicating that the computations of nodes B and C depend on the computation result of node A.

The system generates computational graph information (e.g., as shown in table TB81) based on the data transmission paths shown in CT81. The computational graph information TB81 includes the following information:

(1) Dependency level: Indicates the execution sequence of nodes in the computation sequence. (2) Nodes: Marks the computation nodes in each dependency level. (3) Connection count: Records the total number of adjacent nodes for each node. (4) Computation amount: Indicates the computational complexity of the node computations processed by each node. (5) Data transmission amount: Records the data size transmitted between nodes. (6)Parent node: Identifies the data source nodes for each node.

As shown in the example of FIG. 8, the system (e.g., the configuration controller 110 or the task control processor 111) analyzes the data transmission paths to determine five dependency levels:

Level 1: Node A, which has no preceding dependency nodes; Level 2: Nodes B and C, which depend on the computation result of node A; Level 3: Nodes D, E, and F, which depend on the computation results of nodes B and C; Level 4: Nodes G and H, which depend on the computation results of nodes C, D, and E; Level 5: Node I, which depends on the computation results of nodes F, G, and H.

The system allocates appropriate computation resources to each node based on the computational graph information:

(1) The connection count information determines the number of data transmission channels required for the nodes; (2) The computation amount information evaluates the number of processing units required; (3) The data transmission amount information plans the data transmission paths or assigns suitable memory units to temporarily store computation results. (4) The parent node information ensures the correctness of data dependency, determines whether computation results need to be temporarily stored, plans data access paths, and optimizes the resource allocation of memory units.

In this example, the configuration controller 110 arranges the execution order of nodes based on the dependency level information:

First, node A, which has no dependencies, is configured. After node A completes its computation, nodes B and C (at the same level) can be executed in parallel. Node D waits for the computation result of node B, node E waits for the computation results of nodes B and C, and node F waits for the computation result of node B. Node G waits for the computation results of nodes C and D, and node H waits for the computation result of node E. Finally, node I is executed after the computation results of nodes F, G, and H are completed.

This computational graph information enables the system to effectively manage the allocation and scheduling of computation resources, ensuring the correct execution order of neural network computations.

In more detail, in one embodiment, the task control processor 111 performs dynamic allocation of computation resources based on the computational graph information stored in the workload configuration storage circuit unit 112. Specifically, the task control processor 111 first determines multiple neural network computing tasks corresponding to multiple nodes based on the dependency level information. Next, the task control processor 111 monitors the working states of multiple first arrays 121 and multiple second arrays 122 to identify idle processing units that have not been activated.

When task configuration begins, the task control processor 111 selects an unprocessed target neural network computing task from the multiple neural network computing tasks in sequence according to the dependency level information. For each target neural network computing task, the task control processor 111 performs a series of configuration steps: First, selects suitable target processing units from the idle processing units to execute the target task nodes. Next, selects corresponding target memory units from the first memory units and the second memory units. Finally, selects appropriate target switches from the first switches and the second switches to establish connections between the target processing units and the target memory units.

After completing resource selection, the task control processor 111 sequentially activates the selected hardware resources: Activates the target processing units to execute the target node computations; activates the target memory units to store related data; and activates the target switches to set up the target routing tasks, thereby establishing complete data transmission paths.

It is worth mentioning that, in the example of FIG. 8, a neural network computing task can be defined as a group of node computations at the same dependency level with the same parent node. For example: the first neural network computing task is to execute the computation of node A; the second neural network computing task is to simultaneously execute the computations of nodes B and C (with node A as their common parent node); the third neural network computing task is to execute the computations of nodes D, E, and F (with nodes B or C as their parent nodes); the fourth neural network computing task is to execute the computations of nodes G and H; and the fifth neural network computing task is to execute the computation of node I.

Nodes grouped into the same computation task are designated as task nodes of that computation task. The task control processor 111 allocates a corresponding number of processing units to these task nodes, allowing them to execute the node computations in parallel. All neural network computing tasks are sorted according to their dependency level information to ensure the correct execution sequence. This task design ensures that computation tasks are executed in compliance with data dependency requirements while supporting parallel execution of node computations.

In another embodiment, when selecting hardware resources, the task control processor 111 evaluates the data transmission amount information and the connection number information in the computational graph information. Specifically, the task control processor 111 first selects target memory units based on the data transmission amount information of each target processing unit. This selection mechanism ensures that processing units with higher data transmission requirements are assigned sufficient storage resources (or neighboring memory units with sufficient capacity).

Next, the task control processor 111 selects suitable target processing units from the idle processing units based on the connection number information of the target task nodes. For example, if a target task node has a higher number of connections, the task control processor 111 selects a processing unit with more switch connections to ensure efficient data transmission. Thus, when a specific target processing unit needs to handle a target task node with more connections, that processing unit is configured with more target switch connections.

When executing target node computations, the task control processor 111 processes multiple types of data. In this embodiment, these data include: Computation parameters: Used to configure the computation mode of the target processing units; Node input data: Includes computation results from preceding nodes or original input data; Node computation results: The output data generated after the target processing units execute the computation tasks. The task control processor 111 may decide whether to directly transmit the node input data to the processing units of subsequent nodes or temporarily store it in memory units until the processing units of subsequent nodes are configured.

In the example shown in FIG. 8, when the task control processor 111 processes the computation task of node E, the following factors are considered:

(1) Since node E has three connections (input connections from nodes B and C and an output connection to node H), compared to node D (with fewer connections: 2), the task control processor 111 selects a target processing unit with more switch connections for node E.

(2) Based on the size of the input data and computation parameters required for the node computation of node E, the task control processor 111 configures a target memory unit with sufficient capacity to store the corresponding input data.

(3) The task control processor 111 ensures that the selected target switches can establish the shortest complete data transmission paths to receive computation results from nodes B and C and subsequently execute the computation tasks of node E.

(4) If the computation results of node E need to be temporarily stored, the task control processor 111 determines a neighboring memory unit with sufficient capacity near the target processing unit of node E to temporarily store these results based on the data transmission amount information.

In one embodiment, the task control processor 111 employs a computation capability evaluation mechanism to allocate computation resources. First, the task control processor 111 evaluates whether the available idle processing units can meet the computational demands based on the computation amount information of each target task node and the computational capability of each idle processing unit, where idle processing units refer to those in an “idle” working state (e.g., not executing computations).

When it is confirmed that the number of idle processing units is sufficient, the task control processor 111 considers the following three factors to select and activate target processing units:

(1) Computation amount information: To assess the required scale of computation resources; (2) Idle processing unit capabilities: To ensure that the selected processing units can efficiently handle the specified tasks; (3) Number of relay components in data transmission paths:

To minimize data transmission delays.

For example, when handling the computation task of node E in FIG. 8, the task control processor 111 evaluates the computation amount OP5 of node E, checks the computational capabilities of the available idle processing units, and calculates the transmission path lengths from nodes B and C to each candidate processing unit.

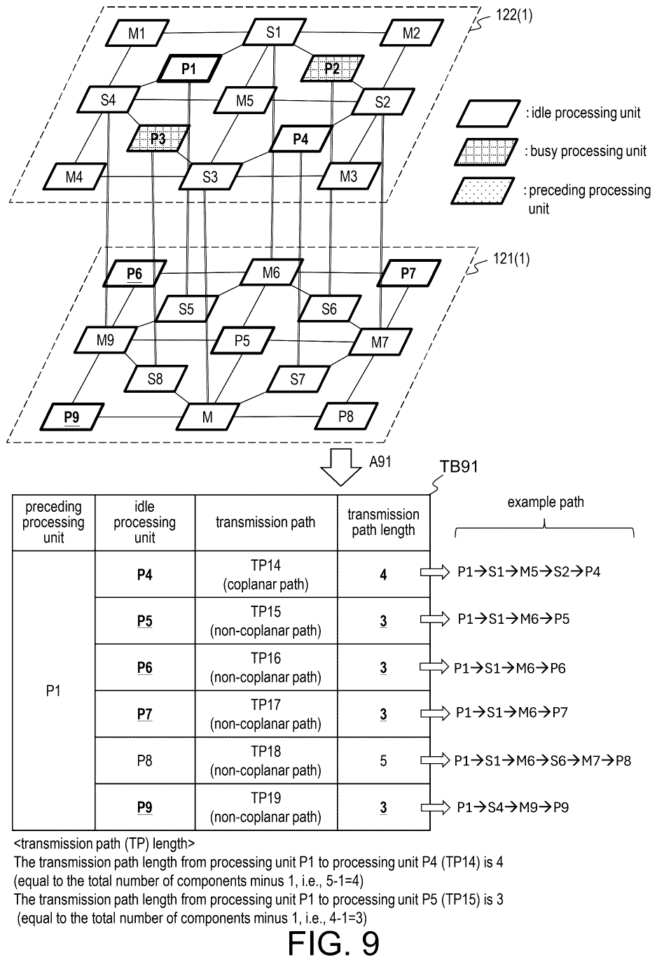

Based on this information, the task control processor 111 selects the optimal combination of target processing units with the shortest transmission paths to optimize computational performance. This is further illustrated in FIG. 9.

FIG. 9 illustrates a schematic diagram of selecting target processing units for a task based on transmission path information according to one embodiment of the present disclosure.

Referring to FIG. 9, in one embodiment, the task control processor 111 selects target processing units based on transmission path information. The upper part of FIG. 9 shows the array configuration of the system architecture, including the spatial distribution of processing units (P), memory units (M), and switches(S), as well as their interconnections. The lower part of FIG. 9 presents transmission path information in table TB91. In this example, assume that the second processing unit P1 is a preceding processing unit that has just completed a node computation, while the second processing units P2 and P3 are busy processing node computations. That is, for the preceding processing unit P1, the idle processing units available are P4, P5, P6, P7, P8, and P9.

In this embodiment, the system analyzes potential transmission paths between the preceding processing unit P1 and each idle processing unit P4, P5, P6, P7, P8, and P9.

(1) Coplanar paths: Such as transmission path TP14, where data transmission from P1 to P4 occurs entirely within the same array plane; and

(2) Non-coplanar paths: Such as transmission paths TP15 to TP19, where data transmission crosses different array planes.

The task control processor 111 calculates the length of each transmission path. The length of a transmission path is determined by subtracting one from the total number of components in the path. For example, since transmission path TP14 (P1→S1→M5→S2→P4) passes through five components, its length is 4 (5−1=4).

For another example, transmission path TP15 (P1→S1→M6→P5) passes through four components, so its length is 3 (4−1=3).

The system prioritizes selecting target processing units with shorter transmission path lengths. As shown in table TB91, except for TP18 with a length of 5, the lengths of other non-coplanar paths (TP15, TP16, TP17, TP19) are all 3, which are shorter than the coplanar path TP14 with a length of 4. This indicates that, in most cases, non-coplanar paths provide more efficient data transmission (fewer total components lead to faster transmission).

When the task control processor 111 determines that the total number of components in the shortest non-coplanar path (e.g., TP15) is less than that in the shortest coplanar path (e.g., TP14), it prioritizes selecting the idle processing unit corresponding to the shortest non-coplanar path (e.g., P5) as the target processing unit. This mechanism leverages the characteristics of the three-dimensional architecture to effectively reduce data transmission delays by selecting shorter vertical transmission paths.

It should be noted that when multiple potential transmission paths have the same length, the task control processor 111 further considers other factors, such as the computational capabilities of idle processing units, the current workload, the number of other idle processing units nearby, and the storage capacity of neighboring memory units, to make the final selection. This path-length-based selection mechanism minimizes data transmission delays and enhances overall system performance.

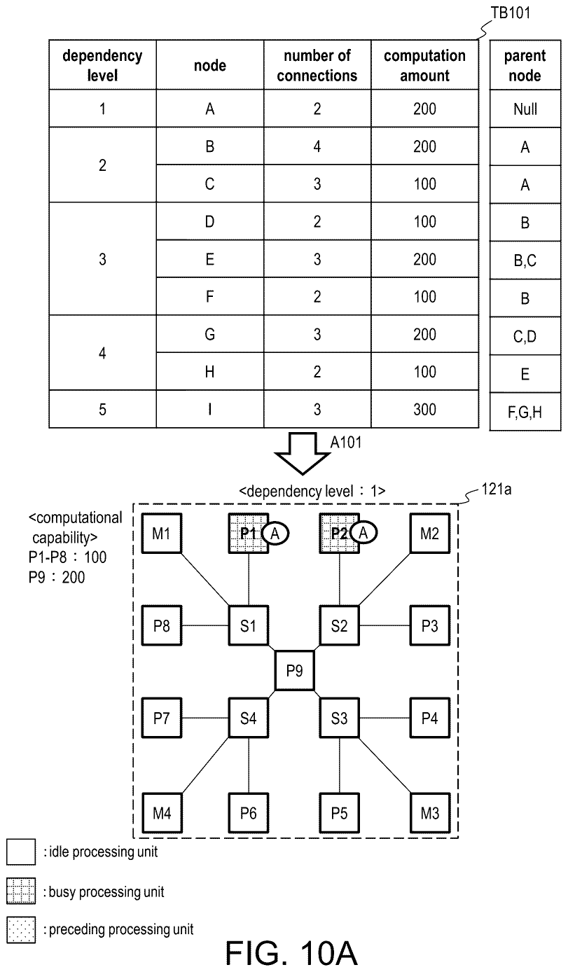

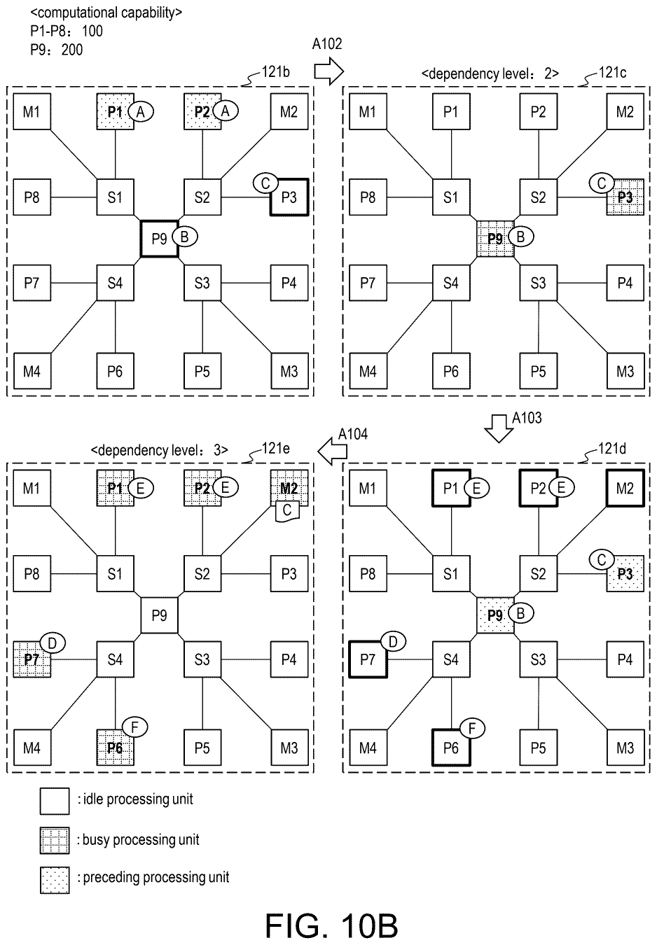

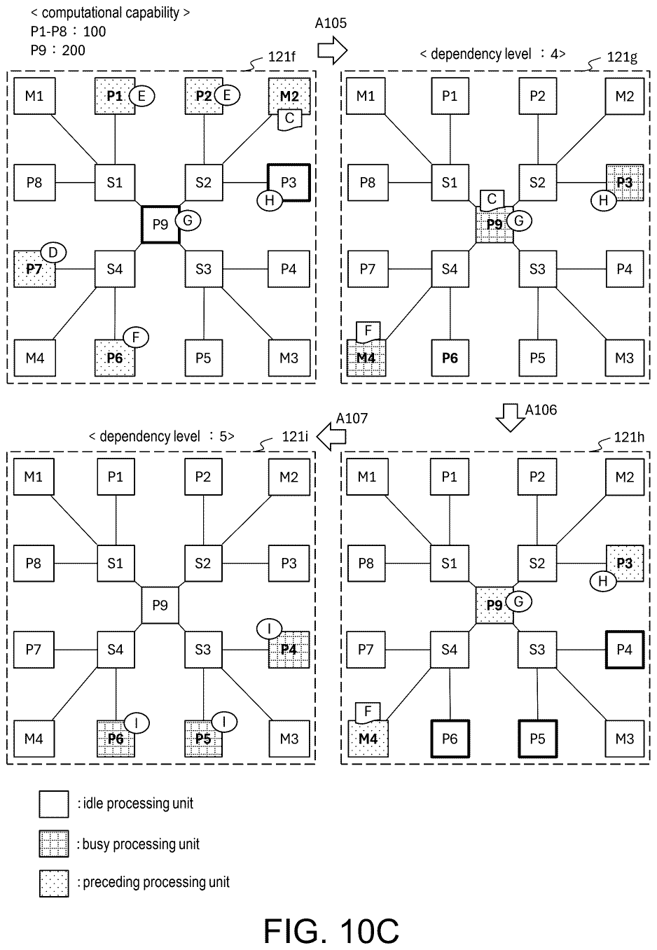

FIGS. 10A to 10C illustrate schematic diagrams of configuring processing units based on computational graph information to execute corresponding neural network computation tasks according to one embodiment of the present disclosure.

Referring to FIG. 10A, in one embodiment, the task control processor 111 configures computation resources based on the computational graph information TB101 to execute neural network computation tasks. Specifically, for node A at dependency level 1, the system performs the following configuration process:

First, the task control processor 111 analyzes the computation characteristics of node A, determining that: the computation amount is 200, which exceeds the computational capability (100) of a standard processing unit (P1-P8); the connection count is 2, indicating that the computation result needs to be transmitted to two subsequent nodes; and that the parent node is Null, allowing computation to start immediately.

Based on this analysis, as shown by arrow A101, the task control processor 111 selects two processing units P1 and P2 in the first array 121a to configure them for executing the computation of node A.

After the configuration is completed, processing units P1 and P2 enter busy states (represented with a grid pattern) and collaboratively execute the node computation task of node A. The task control processor 111 ensures that these two processing units work in coordination to handle the computational demands of node A and prepare the computation result for transmission to other processing units assigned to subsequent nodes B and C.

Referring to FIG. 10B, following the first array 121a shown in FIG. 10A, processing units P1 and P2 complete the node computation in the first array 121b and become preceding processing units (represented with a dotted pattern). According to the computational graph information TB101, the task control processor 111 determines that the subsequent dependency level 2 nodes are B and C. The task control processor 111 selects processing unit P9 to execute the node computation task of node B and selects processing unit P3 to execute the node computation task of node C (indicated with a bold frame around the selected target processing units). These two processing units have the shortest transmission paths to the preceding processing units P1 and P2.

Subsequently, as shown by arrow A102, the system enters to the state of the first array 121c. In this state, since the node computation of node A has been completed, the computation result of node A is integrated and transmitted from processing units P1 and P2 to processing units P3 and P9. Processing units P1 and P2 are reset to idle states (represented with hollow boxes). Processing units P9 and P3 enter busy states (represented with a grid pattern) and respectively execute the node computation tasks of nodes B and C based on the computation result of node A.

In one embodiment, when the task control processor 111 needs to configure data transmission paths for target neural network computation tasks, it performs a systematic resource configuration process. Specifically, the task control processor 111 first monitors the current working states of multiple first arrays 121 and multiple second arrays 122 to identify new idle processing units that have not yet been activated.

After identifying idle processing units, the task control processor 111 determines the next computation task of the target neural network computation task based on the dependency level information. For example, referring to the embodiment shown in FIG. 10B, when the system is in the state of the first array 121c, the task control processor 111 identifies nodes D, E, and F at dependency level 3 as new target neural network computation tasks. Subsequently, the task control processor 111 evaluates the characteristics of the newly identified idle processing units and the new target neural network computation tasks to select appropriate new target processing units. In the aforementioned example, the task control processor 111 selects processing units P7, P6, P1, and P2 as the new target processing units to execute the node computation tasks of nodes D, E, and F. Based on the positional relationships between the current target processing units (P9, P3) and the newly selected target processing units (P7, P6, P1, P2), the task control processor 111 plans the target data transmission paths. Finally, the task control processor 111 configures the routing tasks of the target switches along the transmission paths to ensure that the computation results of the current target processing units are correctly transmitted to the new target processing units, thereby supporting the execution of subsequent computation tasks.

As shown by arrow A103, the system enters to the state of the first array 121d. At this point, the node computations of node B (executed by processing unit P9) and node C (executed by processing unit P3) are completed (represented with a dotted pattern), and these units become preceding processing units. According to the computational graph information TB101, the task control processor 111 determines that the subsequent dependency level 3 nodes are D, E, and F. Based on computational capabilities and computation amounts, the task control processor 111 selects processing unit P7 to execute the node computation task of node D, processing unit P6 to execute the node computation task of node F, and processing units P1 and P2 to collaboratively execute the node computation task of node E.

Subsequently, as shown by arrow A104, the system enters to the state of the first array 121e. Since the node computations of nodes B and C have been completed, the task control processor 111 retrieves the corresponding computation results. The task control processor 111 determines that the node computations of nodes D, E, and F do not require the computation result of node C, but the computation result of node C will be used for the subsequent node H. Therefore, the task control processor 111 temporarily stores the computation result of node C in memory unit M2. Additionally, the computation result of node B is transmitted to processing units P1, P2, P6, and P7. In this state, processing units P1, P2, P6, and P7 enter busy states (represented with a grid pattern) and execute their respective node computation tasks. Specifically, processing unit P7 executes the node computation of node D, processing unit P6 executes the node computation of node F, and processing units P1 and P2 collaboratively execute the node computation of node E. Subsequently, processing units P9 and P3 are reset to idle states.

Referring to FIG. 10C, following the example in FIG. 10B, in the first array 121f, processing units P1 and P2 (executing the node computation of node E), processing unit P7 (executing the node computation of node D), and processing unit P6 (executing the node computation of node F) complete their respective node computations (represented with a dotted pattern), becoming preceding processing units. According to the computational graph information TB101, the task control processor 111 determines that the subsequent dependency level 4 nodes are G and H. It is further determined that node G requires the computation results of nodes C and D, and node H requires the computation result of node E. Additionally, the computation result of node F will be used for the subsequent node I. Therefore, the task control processor 111 temporarily stores the computation result of node F in memory unit M4, as it will be used for the final node computation of node I. Subsequently, the task control processor 111 selects processing unit P9 to execute the node computation of node G and processing unit P3 to execute the node computation of node H (indicated with a bold frame around the selected units).

As shown by arrow A105, the system enters to the state of the first array 121g. In this state, the computation results of nodes D and C are transmitted to processing unit P9, and the computation result of node E is transmitted to processing unit P3. Processing units P9 and P3 transition to busy states (represented with a grid pattern) and execute the node computations of nodes G and H, respectively. Meanwhile, processing units P1, P2, P6, and P7, having completed data transmission, are reset to idle states (represented with hollow boxes).

Subsequently, following the previous state, as shown by arrow A106, the system enters to the state of the first array 121h. In this state, processing unit P9 (executing the node computation of node G) and processing unit P3 (executing the node computation of node H) complete their respective node computations (represented with a dotted pattern), becoming preceding processing units. According to the computational graph information TB101, the task control processor 111 determines that the subsequent dependency level 5 node is I, which requires the computation results of nodes F, G, and H, with a computation amount of 300. Therefore, the task control processor 111 selects processing units P4, P5, and P6 to collaboratively execute the node computation of node I (indicated with a bold frame around the selected units).

Next, as shown by arrow A107, the system enters to the state of the first array 121i. In this state, the computation result of node F is retrieved from memory unit M4, the computation result of node G is retrieved from processing unit P9, and the computation result of node H is retrieved from processing unit P3. These results are integrated and transmitted to processing units P4, P5, and P6. These three processing units change to busy states (represented with a grid pattern) to collaboratively execute the node computation of node I. Since each processing unit has a computation capability of 100, the combined capability of the three units is sufficient to meet the computation amount of 300 required by node I. Additionally, after completing data transmission, processing units P9 and P3 are reset to idle states (represented with hollow boxes).

At this point, the system completes all node computation tasks in the computational graph information TB101. Throughout the process, the task control processor 111 sequentially configures appropriate node computation resources based on the dependency level information, efficiently managing the transmission and temporary storage of node computation results to ensure the correct execution of neural network computation tasks.

It should be understood that, in the above embodiment, for ease of explanation of the control method provided by the present disclosure, only the first array 121 on the same array plane is exemplarily used to implement multiple neural network computation tasks based on the computational graph information. However, this example does not limit the scope of the present disclosure. In other embodiments, as shown in FIG. 9, the task control processor 111 may select processing units from different array planes based on actual computation demands and resource states to achieve more flexible resource allocation.

Before further describing the embodiments of the present disclosure, the mechanism for handling insufficient computational resources in the system is explained. Specifically, when the task control processor 111 determines that the number of idle processing units is insufficient to simultaneously handle all target task nodes, a serialized resource allocation strategy is adopted.

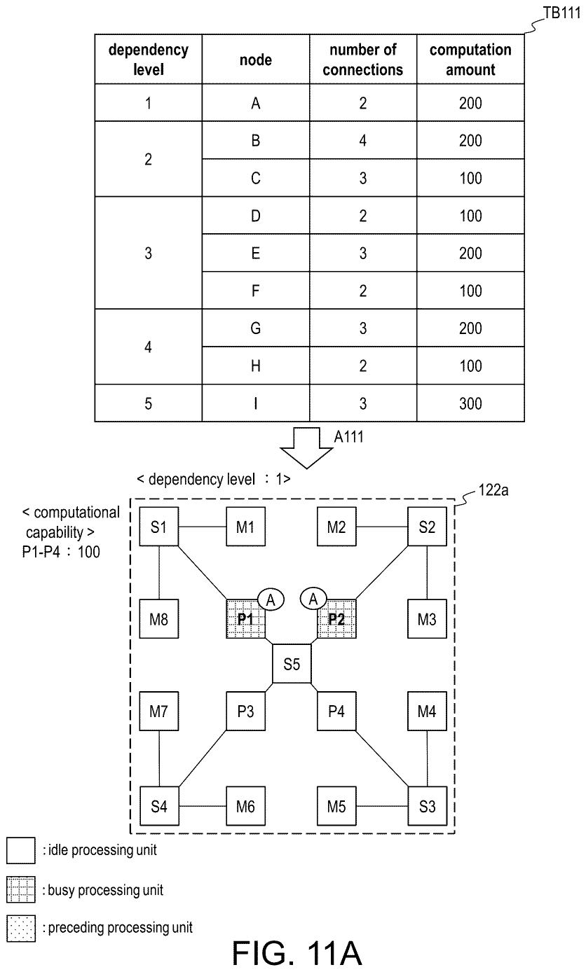

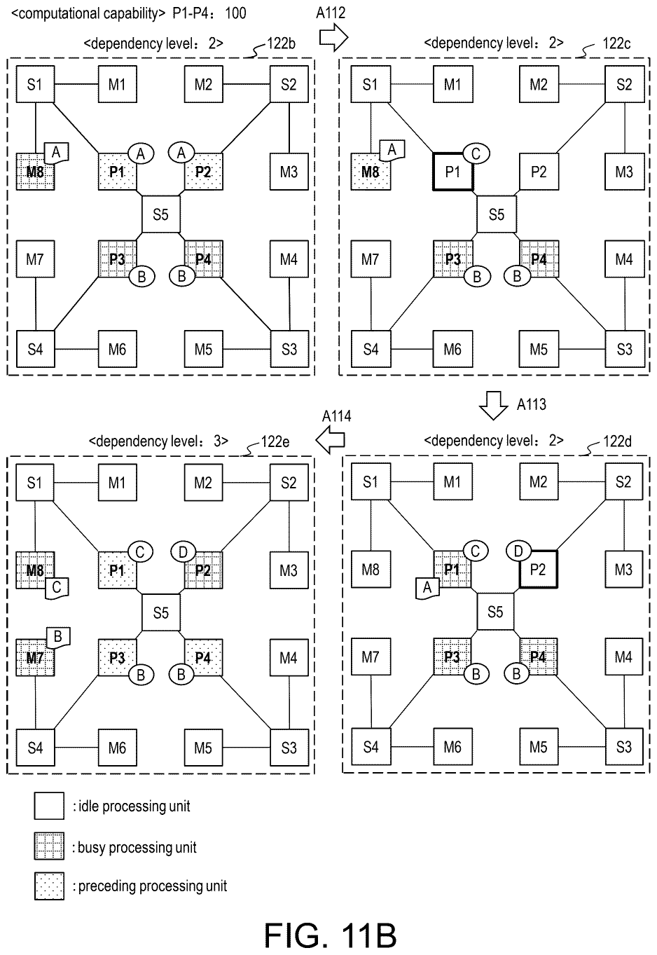

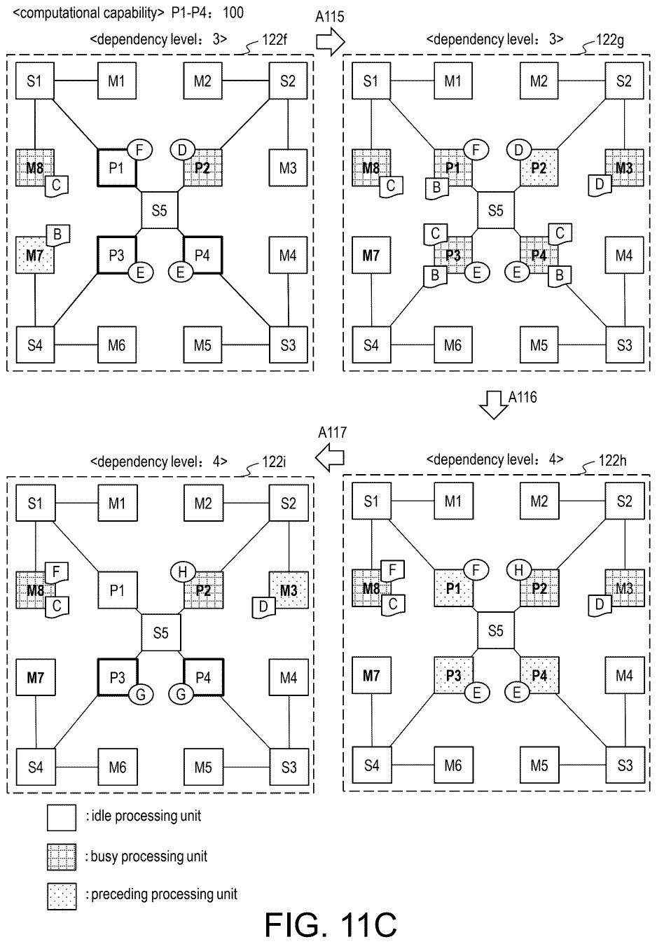

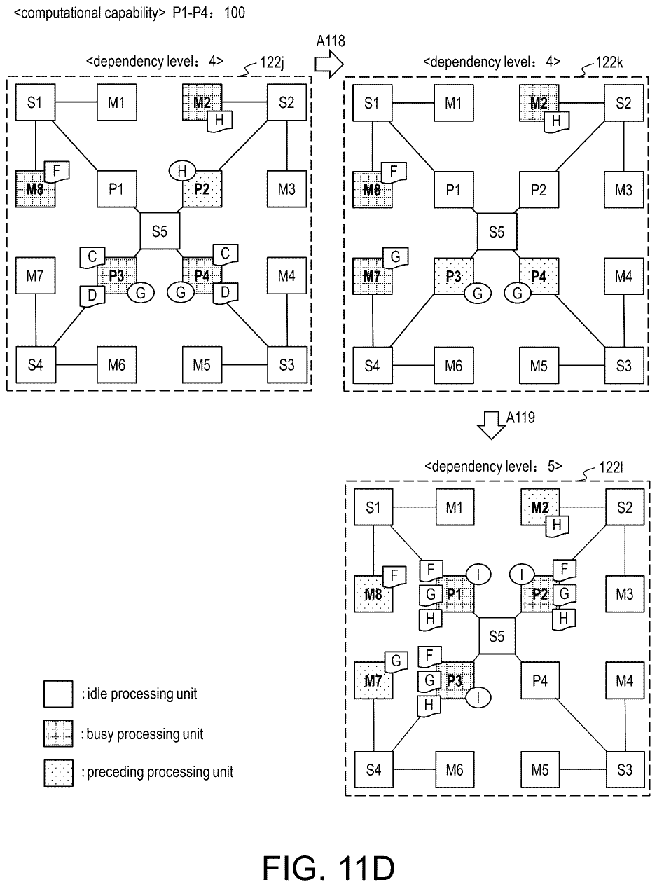

Referring to FIGS. 11A to 11D, an example scenario is illustrated: When the system needs to execute a node computation with a computation amount of 200, but each processing unit has a computational capability of only 100, and the number of available processing units in the system is limited (currently, only one processing unit in the second array is available). In this case, the task control processor 111 must: (1) prioritize allocating limited computational resources to some target task nodes; (2) continuously monitor the working states of the processing units; (3) select the optimal temporary storage locations for the completed computation results; and (4) dynamically reallocate released computational resources.

This resource management mechanism is particularly suitable for scenarios where system resources are constrained during large-scale neural network computations. The following describes how the task control processor 111 ensures the completion of all computation tasks through dynamic resource allocation under such circumstances.

FIGS. 11A to 11D illustrate schematic diagrams of configuring processing units based on computational graph information to execute corresponding neural network computation tasks, according to another embodiment of the present disclosure.

Referring to FIG. 11A, in this embodiment, the task control processor 111 faces a scenario with limited computational resources. According to the computational graph information TB111, node A at dependency level 1 requires a computation amount of 200. However, each processing unit (P1-P4) in the second array 122a has a computational capability of only 100, making it impossible for a single processing unit to independently complete the computation task of node A.

To address this computational resource limitation, the task control processor 111 first evaluates the available resources in the second array 122a. After evaluation, the task control processor 111 observes that processing units P1 and P2 can establish a direct data transmission channel through switch S5, and their combined computational capability (200) exactly meets the computational requirement of node A. Based on this evaluation, the task control processor 111 selects processing units P1 and P2 to collaboratively execute the computation task of node A.

As shown by arrow A111, after completing the resource configuration, processing units P1 and P2 transition to busy states (represented with a grid pattern) and begin computation, while processing units P3 and P4 remain in idle states (represented with hollow boxes) for future use. Meanwhile, memory units M1 through M8 also remain idle, ready to store the subsequent node computation results. This resource configuration demonstrates how the system completes high-computation-demand tasks under constrained computational capabilities by utilizing multiple processing units collaboratively.

Referring to FIG. 11B, continuing from the previous scenario, in the second array 122b, following the configuration in the second array 122a, processing units P1 and P2 complete the computation task of node A (represented with a dotted pattern). According to the computational graph information TB111, the task control processor 111 determines that dependency level 2 includes nodes B and C, where node B requires a computation amount of 200, and node C requires a computation amount of 100. However, since each processing unit has a computational capability of only 100, the task control processor 111 must allocate multiple processing units for node B.

Based on this computational demand, the task control processor 111 selects processing units P3 and P4 to execute the computation task of node B and selects memory unit M8 to temporarily store the computation result of node A (since the computation task of node C requires the computation result of node A). In this configuration, processing units P3 and P4 transition to busy states (represented with a grid pattern) to collaboratively execute the computation task of node B.

As shown by arrow A112, the system transitions to the state of the second array 122c. In this state, processing units P3 and P4 continue executing the computation task of node B, while processing unit P1 is selected to execute the computation task of node C, which requires a computation amount of 100. At this point, the computation result of node A stored in memory unit M8 is transmitted to processing unit P1, while other unallocated processing units and memory units remain idle for future use.

Subsequently, as shown by arrow A113, the system transitions to the state of the second array 122d. According to the computational graph information TB111, the parent node of node C is node A, and a computation amount of 100 is required. Therefore, the task control processor 111 transmits the computation result of node A from memory unit M8 to processing unit P1, enabling processing unit P1 to transition to a busy state (represented with a grid pattern) and execute the computation task of node C.

Since there is one idle processing unit remaining, the task control processor 111 determines that the next node to process is node D, based on the computational graph information TB111. Since the parent node of node D is node B, and a computation amount of 100 is required, the task control processor 111 selects processing unit P2 to execute the computation task of node D. Meanwhile, processing units P3 and P4 remain busy to complete the computation task of node B.

As shown by arrow A114, the system transitions to the state of the second array 122e. At this point, processing units P3 and P4 complete the computation task of node B (represented with a dotted pattern), becoming preceding processing units. According to the computational graph information TB111, since the computation result of node B will be used for the computation tasks of nodes D, E, and F, and there are no idle processing units available for allocation, the task control processor 111 temporarily stores the computation result of node B in memory unit M7 (represented with a grid pattern). Additionally, since the computation result of node C will be used for the subsequent computation of node G, the task control processor 111 also temporarily stores it in memory unit M8 (represented with a grid pattern). Furthermore, processing unit P1 completes the computation task of node C at this point (represented with a dotted pattern), becoming a preceding processing unit. At this stage, the neural network computation tasks at dependency level 2 are deemed complete. The task control processor 111 then selects the next neural network computation tasks for processing. According to the computational graph information TB111, the task control processor 111 determines that dependency level 3 includes nodes D, E, and F, where node E requires a computation amount of 200 and depends on the computation results of nodes B and C, node D requires a computation amount of 100 and depends on the computation result of node B, and node F requires a computation amount of 100 and depends on the computation result of node B.

Processing unit P2 is executing the node computation task of node D (represented with a grid pattern), entering a busy state.
Referring to FIG. 11C, continuing from the example in FIG. 11B, in the second array 122f, memory unit M7 temporarily stores the computation result of node B, and memory unit M8 temporarily stores the computation result of node C. The task control processor 111 configures processing units P3 and P4 to execute the node computation task of node E and processing unit P1 to execute the node computation task of node F. Processing unit P2 continues executing the node computation task of node D.

As shown by arrow A115, the system transitions to the state of the second array 122g. In this state, the computation results of nodes B and C are transmitted from memory units M7 and M8 to the respective processing units. The computation result of node B is transmitted to processing unit P1 (assigned to node F) and processing units P3 and P4 (assigned to node E). Since the computation result of node B is no longer required for subsequent nodes, the task control processor 111 deletes it from memory unit M7. On the other hand, as the computation result of node C is required for subsequent node G, it is retained in memory unit M8.

Processing units P3 and P4 enter busy states (represented with a grid pattern) to execute the node computation task of node E, and processing unit P1 enters a busy state to execute the node computation task of node F. Meanwhile, processing unit P2 completes the node computation task of node D (represented with a dotted pattern), becoming a preceding processing unit. As the computation result of node D is required for subsequent node computations and no idle processing units are available, the task control processor 111 temporarily stores it in memory unit M3 (represented with a grid pattern).

Subsequently, as shown by arrow A116, the system transitions to the state of the second array 122h. At this point, processing units P3 and P4 complete the node computation task of node E (represented with a dotted pattern), and processing unit P1 completes the node computation task of node F (represented with a dotted pattern). These processing units become preceding processing units and are prepared to be reset to idle states. At this stage, dependency level 3 is completed, and the system begins processing the neural network computation tasks at dependency level 4 (nodes G and H).

As the computation result of node D is required for the subsequent node G, it is stored in memory unit M3. On the other hand, as the computation result of node F is required for the subsequent node I, it is stored in memory unit M8.

Subsequently, as shown by arrow A117, the system transitions to the state of the second array 122i. According to the computational graph information TB111, the task control processor 111 determines that dependency level 4 includes the unprocessed node G. Therefore, the task control processor 111 selects processing units P3 and P4 to execute the node computation task of node G. Processing unit P2 continues executing the node computation task of node H.

Referring to FIG. 11D, continuing from the example in FIG. 11C, in the second array 122j, the computation results of nodes C and D are transmitted from memory units M8 and M3 to the respective processing units. Since node G requires the computation results of nodes C and D and has a computation amount of 200, two processing units are needed to execute the task. The task control processor 111 configures processing units P3 and P4 to execute the node computation task of node G (represented with a grid pattern). At the same time, according to the computational graph information TB111, the task control processor 111 determines that node H requires the computation result of node E and has a computation amount of 100. Therefore, it selects processing unit P2 to execute the node computation task of node H. As the computation result of node H is required for the subsequent node I and no idle processing units are available, the task control processor 111 temporarily stores it in memory unit M2 (represented with a grid pattern). Additionally, as the computation result of node F is required for the subsequent node I, the task control processor 111 continues to store it in memory unit M8.

Subsequently, as shown by arrow A118, the system transitions to the state of the second array 122k. In this state, processing unit P2 has been reset, and processing units P3 and P4 complete the node computation task of node G (represented with a dotted pattern), becoming preceding processing units. As the computation result of node G is required for the subsequent node I and no idle processing units are available to execute the node computation task of node I, the task control processor 111 temporarily stores it in memory unit M7. At the same time, the computation result of node H remains stored in memory unit M2, as it is still required for the subsequent node I. At this stage, dependency level 4 is completed, and the system prepares to process the neural network computation tasks at dependency level 5 (node I).

Continuing from the state of the second array 122k, as shown by arrow A119, the system transitions to the state of the second array 122l. In this state, the task control processor 111 determines, based on the computational graph information TB111, that node I at dependency level 5 requires the computation results of nodes F, G, and H, with a computation amount of 300. Since each processing unit has a computational capability of 100, three processing units are required to collaboratively execute the node computation task of node I.

Specifically, the computation result of node F is transmitted from memory unit M8, the computation result of node G is transmitted from memory unit M7, and the computation result of node H is transmitted from memory unit M2 to the corresponding processing units. The task control processor 111 configures processing units P1, P2, and P3 to execute the node computation task of node I (represented with a grid pattern).

After the data transmission is completed, the computation result of node F is transmitted to processing unit P1 and is no longer required by any subsequent nodes, so it is deleted from memory unit M8. Similarly, the computation result of node G, which has been transmitted to processing unit P2, is deleted from memory unit M7, and the computation result of node H, which has been transmitted to processing unit P3, would be deleted from memory unit M2, as no subsequent nodes require these results.

At this point, the system has completed the configuration of all node computation tasks in the computational graph information TB111. The above example describes how, under constrained computational resources, dynamic resource allocation and temporary management of computation results are utilized to gradually complete complex neural network computation tasks.

In one embodiment, the three-dimensional coarse-grained reconfigurable array architecture system 100 of the present disclosure also implements a dynamic resource adjustment mechanism. Specifically, the configuration controller 110 may dynamically adjust the performance parameters of each memory unit and processing unit based on computational demands.

For memory units, the configuration controller 110 may adjust the following parameters: storage capacity allocation, dynamically partitioning or merging storage space to adjust the capacity of individual memory units; access bandwidth, modifying the operating clock frequency and data bus width of memory units to change data access speed; cache configuration, dynamically adjusting the size and organization of caches to optimize data access patterns for specific computational tasks.

For processing units, the configuration controller 110 may adjust the following parameters: computational precision, switching from floating-point computations to fixed-point computations when high precision is unnecessary, thereby enhancing processing efficiency; operating frequency, dynamically adjusting the operating clock frequency of processing units based on the complexity of computation tasks; processing mode, reconfiguring a single processing unit into multiple smaller processing units to improve parallel processing capabilities.

In practical implementation, these dynamic adjustments may be achieved through the following technologies: dynamic voltage and frequency scaling (DVFS), for real-time adjustment of operating voltage and frequency; reconfigurable processing array, supporting dynamic partitioning and merging of processing units; adaptive memory controller, dynamically adjusting memory access modes and bandwidth allocation; dynamic resource allocation engine, responsible for determining the optimal resource allocation strategy based on workload characteristics. In other words, when the computational capability of an existing processing unit is insufficient to handle the computation amount of a specific node, the system may dynamically enhance the computational capability of the processing unit so that it can be assigned to the specific node. This eliminates the need for multiple processing units to execute the node computation task, reducing data integration complexity and improving overall efficiency.

Based on the above, the three-dimensional coarse-grained reconfigurable array architecture system and its control methods provided in one or more embodiments of the present disclosure achieve system performance improvements through the following technical features:

1. Through the interleaved stacking configuration of heterogeneous arrays, a three-dimensional data transmission architecture is established, optimizing data transmission paths. Specifically, when data needs to be transmitted between different functional arrays, the system can select the shortest vertical transmission path, avoiding transmission delays caused by traversing multiple components in traditional two-dimensional architectures.

2. By employing a dynamic resource allocation mechanism, the system flexibly allocates computational resources to meet different computational demands. For example, when encountering a node computation task requiring a larger computation amount, the system can configure multiple processing units to collaboratively execute the task, ensuring optimal computational performance.

3. Through intelligent temporary storage management of computation results, the system maintains efficient computational processes even under constrained computational resources. When the computation result of a node needs to be provided to multiple subsequent nodes and there are insufficient processing units available, the system temporarily stores the result in memory units until all relevant nodes complete their computations before releasing it.

4. Utilizing dependency level information for task scheduling enables the system to maximize computational resource utilization while ensuring computational correctness. The system resets processing units that have completed computations to idle states in a timely manner, making them available for subsequent computation tasks.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A three-dimensional coarse-grained reconfigurable array architecture system, adapted for implementing a neural network model, comprising:
a plurality of first arrays, wherein each first array comprises:
a plurality of first processing units, configured to execute neural network computing tasks of nodes of the neural network model;
a plurality of first memory units, configured to store data of corresponding neural network computing tasks, wherein in each first array, a number of the plurality of first processing units is greater than a number of the plurality of first memory units; and
a plurality of first switches, configured to execute corresponding routing tasks, wherein the first switches are not directly connected to each other, wherein the plurality of first processing units, the plurality of first memory units, and the plurality of first switches are distributed on an array plane of the first array;
a plurality of second arrays, wherein each second array comprises:
a plurality of second processing units, configured to execute neural network computing tasks of nodes of the neural network model;
a plurality of second memory units, configured to store data of corresponding neural network computing tasks, wherein a number of the plurality of second memory units is greater than a number of the plurality of second processing units; and
a plurality of second switches, configured to execute corresponding routing tasks, wherein the second switches are not directly connected to each other, wherein the plurality of second processing units, the plurality of second memory units, and the plurality of second switches are distributed on an array plane of the second array;
an input/output interface, configured to receive input data and transmit processing results;
a configuration controller, electrically connected to the plurality of first arrays and the plurality of second arrays, wherein each first array and each second array are alternately stacked, wherein arrays adjacent to each first array in a vertical direction with respect to the corresponding array plane are the second arrays, wherein arrays adjacent to each second array in a vertical direction with respect to the corresponding array plane are the first arrays,
wherein the configuration controller is configured to:
monitor respective working states of the plurality of first arrays and the plurality of second arrays;
according to computational graph information corresponding to the neural network model, dynamically manage activation and deactivation of the plurality of first processing units, the plurality of first memory units, the plurality of first switches, the plurality of second memory units, the plurality of second processing units, and the plurality of second switches, so as to execute a plurality of neural network computing tasks of the neural network model.

2. The three-dimensional coarse-grained reconfigurable array architecture system as claimed in claim 1,
wherein the neural network computing tasks comprise matrix operations, convolution operations, and vector operations,
wherein the data of corresponding neural network computing comprises: weight parameters, node computation results of node computations, and computation input data.

3. The three-dimensional coarse-grained reconfigurable array architecture system as claimed in claim 1, wherein in each first array: each first processing unit and each first memory unit are not directly connected to each other, and each first processing unit and each first memory unit are connected at least through one first switch;
wherein in each second array: each second processing unit and each second memory unit are not directly connected to each other, and each second processing unit and each second memory unit are connected at least through one second switch;
wherein first switches of each first array are vertically connected to second processing units or second memory units of adjacent second arrays, wherein first data of each first array is transmitted through the first switches to the second processing units or the second memory units of the adjacent second arrays, so as to execute cross-layer transmission;
wherein second switches of each second array are vertically connected to first memory units or first processing units of adjacent first arrays, wherein second data of each second array is transmitted through the second switches to the first memory units or the first processing units of the adjacent first arrays, so as to execute cross-layer transmission.

4. The three-dimensional coarse-grained reconfigurable array architecture system as claimed in claim 1, wherein the configuration controller comprises:
a workload configuration storage circuit unit, configured to store the computational graph information of the neural network model, wherein the computational graph information comprises:
dependency level information of respective nodes of a plurality of nodes, configured to indicate execution order of the plurality of nodes in the neural network model, wherein nodes of a same execution level are capable of executed in parallel, and nodes of different execution levels are executed sequentially;
connection number information between the plurality of nodes, configured to indicate a total number of adjacent nodes connected to each node;
data transmission amount information between the plurality of nodes, configured to indicate data size on data transmission paths; and
computation amount information of respective nodes of the plurality of nodes, configured to indicate computation amount of node computation executed by each node; and
a task control processor, configured to dynamically manage the activation and the deactivation of the plurality of first processing units, the plurality of first memory units, the plurality of first switches, the plurality of second memory units, the plurality of second processing units, and the plurality of second switches according to the computational graph information, so as to execute the plurality of neural network computing tasks of the neural network model.

5. The three-dimensional coarse-grained reconfigurable array architecture system as claimed in claim 4, wherein the task control processor is further configured to:
determine a plurality of neural network computing tasks corresponding to the plurality of nodes according to the dependency level information, wherein each neural network computing task corresponds to one or more task nodes to be executed in the neural network computing tasks;
obtain a plurality of idle processing units from the plurality of first processing units and the plurality of second processing units according to respective current working states of the plurality of first arrays and the plurality of second arrays, wherein the plurality of idle processing units have not been activated;
sequentially select an unprocessed target neural network computing task from the plurality of neural network computing tasks according to the dependency level information, and execute following steps:
select one or more target processing units corresponding to one or more target task nodes of the target neural network computing task from the plurality of idle processing units, select one or more target memory units corresponding to the one or more target processing units from the plurality of first memory units and the plurality of second memory units, and select one or more target switches between the one or more target processing units and the one or more target memory units from the plurality of first switches and the plurality of second switches according to the plurality of idle processing units and the target neural network computing task;
activate each target processing unit to execute target node computation of corresponding target task nodes;
activate each target memory unit to store data of corresponding target node computation;
activate each target switch to set target routing tasks of the target switches, so as to set target data transmission paths of the target neural network computing task.

6. The three-dimensional coarse-grained reconfigurable array architecture system as claimed in claim 5, wherein the task control processor is further configured to:
select the one or more target memory units according to respective data transmission amount information of the one or more target processing units; and
select the one or more target processing units corresponding to the one or more target task nodes from the plurality of idle processing units according to the connection number information between the one or more target task nodes, wherein a specific target processing unit corresponding to more connections is connected to more target switches.

7. The three-dimensional coarse-grained reconfigurable array architecture system as claimed in claim 5, wherein the data of corresponding target node computation comprises at least one of:
computation parameters of the corresponding target node computation;
node input data of the corresponding target node computation; and
node computation result of the corresponding target node computation.

8. The three-dimensional coarse-grained reconfigurable array architecture system as claimed in claim 5, wherein in configuring the target data transmission paths of the target neural network computing task, the task control processor is further configured to:
obtain a plurality of new idle processing units from the plurality of first processing units and the plurality of second processing units according to respective current working states of the plurality of first arrays and the plurality of second arrays;
obtain a next neural network computing task of the target neural network computing task as a new target neural network computing task according to the dependency level information;
select one or more new target processing units corresponding to one or more new target task nodes of the new target neural network computing task from the plurality of new idle processing units according to the plurality of new idle processing units and the new target neural network computing task;
determine the target data transmission paths according to the one or more target processing units and the one or more new target processing units;
set the target routing tasks of target switches corresponding to the target data transmission paths to transmit node computation result of the target node computation executed by the one or more target processing units to the one or more new target processing units through the corresponding target switches.

9. The three-dimensional coarse-grained reconfigurable array architecture system as claimed in claim 5, wherein in operation of determining the plurality of neural network computing tasks corresponding to the plurality of nodes according to the dependency level information, the task control processor is further configured to:
group one or more specific nodes belonging to a same execution level into a same neural network computing task according to the dependency level information, wherein the one or more specific nodes belonging to the same neural network computing task serve as the one or more task nodes corresponding to the neural network computing task, and one or more processing units assigned to the one or more task nodes execute corresponding node computation in parallel, wherein the plurality of neural network computing tasks are sorted according to corresponding dependency level information.

10. The three-dimensional coarse-grained reconfigurable array architecture system as claimed in claim 5, wherein the task control processor is further configured to:
determine whether the plurality of idle processing units are sufficient to be assigned to the plurality of target task nodes according to computation amount information of each target task node and computational capability of each idle processing unit; and
when the plurality of idle processing units are sufficient to be assigned to the plurality of target task nodes, select and activate the one or more target processing units according to following information:
the computation amount information of each target task node;
the computational capability of each idle processing unit; and
a total number of relay components required to be passed through on transmission paths between each idle processing unit and each corresponding preceding node.

11. The three-dimensional coarse-grained reconfigurable array architecture system as claimed in claim 5, wherein the task control processor is further configured to:
when the plurality of idle processing units are insufficient to be assigned to the one or more target task nodes, execute following steps:
assign all of the plurality of idle processing units to one or more first target task nodes among the one or more target task nodes;
monitor working state of each processing unit to obtain a specific processing unit that has completed node computation;
elect a specific memory unit having shortest transmission path with the specific processing unit from the plurality of first memory units and the plurality of second memory units to store node computation result of the specific processing unit, wherein the shortest transmission path has a minimum total number of components;
reset the specific processing unit as a new idle processing unit;
select a third target task node from one or more second target task nodes that have not been assigned among the one or more target task nodes, and assign the new idle processing unit to the third target task node to execute node computation corresponding to the third target task node; and
continue executing the step of monitoring working state of each processing unit to obtain the specific processing unit that has completed node computation until all target task nodes have been assigned.

12. The three-dimensional coarse-grained reconfigurable array architecture system as claimed in claim 5, wherein step of selecting the one or more target processing units corresponding to the one or more target task nodes of the target neural network computing task from the plurality of idle processing units comprises:
in response to determining that a preceding processing unit corresponding to a preceding node has completed the node computation;
obtain transmission paths between each idle processing unit and the preceding processing unit, wherein the transmission paths comprise:
a coplanar path, which is a transmission path when the idle processing unit and the preceding processing unit are located on a same array plane; and
a non-coplanar path, which is a transmission path when the idle processing unit and the preceding processing unit are located on different array planes; and
in response to determining that a total number of components included in a shortest one of the non-coplanar paths is less than a total number of components included in a shortest one of the coplanar paths, select a specific idle processing unit corresponding to the shortest non-coplanar path as one of the one or more target processing units.

13. A control method of a three-dimensional coarse-grained reconfigurable array architecture system, wherein the three-dimensional coarse-grained reconfigurable array architecture system is for implementing a neural network model, comprising:
through a configuration controller, monitoring respective working states of a plurality of first arrays and a plurality of second arrays of the three-dimensional coarse-grained reconfigurable array architecture system,
wherein each first array comprises:
a plurality of first processing units configured to execute neural network computing tasks of nodes of the neural network model;
a plurality of first memory units configured to store data of corresponding neural network computing tasks, wherein in each first array, a number of the plurality of first processing units is greater than a number of the plurality of first memory units; and
a plurality of first switches configured to execute corresponding routing tasks, wherein the first switches are not directly connected to each other, wherein the plurality of first processing units, the plurality of first memory units, and the plurality of first switches are distributed on an array plane of the first array;
wherein each second array comprises:
a plurality of second processing units configured to execute neural network computing tasks of nodes of the neural network model;
a plurality of second memory units configured to store data of corresponding neural network computing tasks, wherein a number of the plurality of second memory units is greater than a number of the plurality of second processing units; and
a plurality of second switches configured to execute corresponding routing tasks, wherein the second switches are not directly connected to each other, wherein the plurality of second processing units, the plurality of second memory units, and the plurality of second switches are distributed on an array plane of the second array,
wherein the configuration controller is electrically connected to the plurality of first arrays and the plurality of second arrays, wherein each first array and each second array are alternately stacked, wherein arrays adjacent to each first array in a vertical direction with respect to the corresponding array plane are the second arrays, wherein arrays adjacent to each second array in a vertical direction with respect to the corresponding array plane are the first arrays; and
through the configuration controller, dynamically managing activation and deactivation of the plurality of first processing units, the plurality of first memory units, the plurality of first switches, the plurality of second memory units, the plurality of second processing units, and the plurality of second switches according to computational graph information corresponding to the neural network model, so as to execute a plurality of neural network computing tasks of the neural network model.

14. The control method as claimed in claim 13,
wherein the neural network computing tasks comprise matrix operations, convolution operations, and vector operations,
wherein the data of corresponding neural network computing comprises: weight parameters, node computation result of node computations, and computation input data.

15. The control method as claimed in claim 13, wherein in each first array: each first processing unit and each first switch are not directly connected to each other, and each first processing unit and each first switch are connected at least through one first switch;
wherein in each second array: each second processing unit and each second switch are not directly connected to each other, and each second processing unit and each second switch are connected at least one through second switch;
wherein first switches of each first array are vertically connected to second processing units of adjacent second arrays, wherein first data is transmitted through the first switches to the second processing units of the adjacent second arrays, so as to execute cross-layer transmission;
wherein second switches of each second array are vertically connected to first memory units of adjacent first arrays, wherein second data is transmitted through the second switches to first processing units of the adjacent first arrays, so as to execute cross-layer transmission.

16. The control method as claimed in claim 13, wherein the configuration controller comprises:
a workload configuration storage circuit unit configured to store the computational graph information of the neural network model, wherein the computational graph information comprises:
dependency level information of respective nodes of a plurality of nodes, configured to indicate execution order of the plurality of nodes in the neural network model, wherein nodes of a same execution level are capable of executed in parallel, and nodes of different execution levels are executed sequentially;
connection number information between the plurality of nodes, configured to indicate a total number of adjacent nodes connected to each node;
data transmission amount information between the plurality of nodes, configured to indicate data size on data transmission paths; and
computation amount information of respective nodes of the plurality of nodes, configured to indicate computation amount of node computation executed by each node; and
a task control processor configured to dynamically manage the activation and the deactivation of the plurality of first processing units, the plurality of first memory units, the plurality of first switches, the plurality of second memory units, the plurality of second processing units, and the plurality of second switches according to the computational graph information, so as to execute the plurality of neural network computing tasks of the neural network model.

17. The control method as claimed in claim 16, wherein the method further comprises:
through the task control processor, determining the plurality of neural network computing tasks corresponding to the plurality of nodes according to the dependency level information, wherein each neural network computing task corresponds to one or more task nodes to be executed in the neural network computing tasks;
through the task control processor, obtaining a plurality of idle processing units from the plurality of first processing units and the plurality of second processing units according to respective current working states of the plurality of first arrays and the plurality of second arrays, wherein the plurality of idle processing units have not been activated;
through the task control processor, sequentially selecting an unprocessed target neural network computing task from the plurality of neural network computing tasks according to the dependency level information, and executing following steps:
selecting one or more target processing units corresponding to one or more target task nodes of the target neural network computing task from the plurality of idle processing units, selecting one or more target memory units corresponding to the one or more target processing units from the plurality of first memory units and the plurality of second memory units, and selecting one or more target switches between the one or more target processing units and the one or more target memory units from the plurality of first switches and the plurality of second switches according to the plurality of idle processing units and the target neural network computing task;
activating each target processing unit to execute target node computation of corresponding target task nodes;
activating each target memory unit to store data of corresponding target node computation;
activating each target switch to set target routing tasks of the target switches, so as to set target data transmission paths of the target neural network computing task.

18. The control method as claimed in claim 17, wherein the method further comprises:
through the task control processor, selecting the one or more target memory units according to respective data transmission amount information of the one or more target processing units; and
through the task control processor, selecting the one or more target processing units corresponding to the one or more target task nodes from the plurality of idle processing units according to the connection number information between the one or more target task nodes, wherein a specific target processing unit corresponding to more connections is connected to more target switches.

19. The control method as claimed in claim 17, wherein the data of corresponding target node computation comprises at least one of:
computation parameters of the corresponding target node computation;
node input data of the corresponding target node computation; and
node computation result of the corresponding target node computation.

20. The control method as claimed in claim 17, wherein step of configuring the target data transmission paths of the target neural network computing task comprises:
through the task control processor, obtaining a plurality of new idle processing units from the plurality of first processing units and the plurality of second processing units according to respective current working states of the plurality of first arrays and the plurality of second arrays;
through the task control processor, obtaining a next neural network computing task of the target neural network computing task as a new target neural network computing task according to the dependency level information;
through the task control processor, selecting one or more new target processing units corresponding to one or more new target task nodes of the new target neural network computing task from the plurality of new idle processing units according to the plurality of new idle processing units and the new target neural network computing task;
through the task control processor, determining the target data transmission paths according to the one or more target processing units and the one or more new target processing units;
through the task control processor, setting the target routing tasks of target switches corresponding to the target data transmission paths to transmit node computation result of the target node computation executed by the one or more target processing units to the one or more new target processing units through the corresponding target switches.

21. The control method as claimed in claim 17, wherein step of determining the plurality of neural network computing tasks corresponding to the plurality of nodes according to the dependency level information comprises:
through the task control processor, grouping one or more specific nodes belonging to a same execution level into a same neural network computing task according to the dependency level information, wherein the one or more specific nodes belonging to the same neural network computing task serve as the one or more task nodes corresponding to the neural network computing task, and one or more processing units assigned to the one or more task nodes execute corresponding node computation in parallel, wherein the plurality of neural network computing tasks are sorted according to corresponding dependency level information.

22. The control method as claimed in claim 17, wherein the method further comprises:
through the task control processor, determining whether the plurality of idle processing units are sufficient to be assigned to the plurality of target task nodes according to computation amount information of each target task node and computational capability of each idle processing unit; and
through the task control processor, when the plurality of idle processing units are sufficient to be assigned to the plurality of target task nodes, selecting and activating the one or more target processing units according to following information:
the computation amount information of each target task node;
the computational capability of each idle processing unit; and
a total number of relay components required to be passed through on transmission paths between each idle processing unit and each corresponding preceding node.

23. The control method as claimed in claim 17, wherein the method further comprises:
through the task control processor, when the plurality of idle processing units are insufficient to be assigned to the one or more target task nodes, executing following steps:
through the task control processor, assigning all of the plurality of idle processing units to one or more first target task nodes among the one or more target task nodes;
through the task control processor, monitoring working state of each processing unit to obtain a specific processing unit that has completed node computation;
through the task control processor, selecting a specific memory unit having shortest transmission path with the specific processing unit from the plurality of first memory units and the plurality of second memory units to store node computation result of the specific processing unit, wherein the shortest transmission path has a minimum total number of components;
through the task control processor, resetting the specific processing unit as a new idle processing unit;
through the task control processor, selecting a third target task node from one or more second target task nodes that have not been assigned among the one or more target task nodes, and assigning the new idle processing unit to the third target task node to execute node computation corresponding to the third target task node; and
through the task control processor, continuing executing the step of monitoring working state of each processing unit to obtain the specific processing unit that has completed node computation until all target task nodes have been assigned.

24. The control method as claimed in claim 17, wherein step of selecting the one or more target processing units corresponding to the one or more target task nodes of the target neural network computing task from the plurality of idle processing units comprises:
through the task control processor, in response to determining that a preceding processing unit corresponding to a preceding node has completed the node computation;
through the task control processor, obtaining transmission paths between each idle processing unit and the preceding processing unit, wherein the transmission paths comprise:
a coplanar path, which is a transmission path when the idle processing unit and the preceding processing unit are located on a same array plane; and
a non-coplanar path, which is a transmission path when the idle processing unit and the preceding processing unit are located on different array planes; and
through the task control processor, in response to determining that a total number of components included in a shortest one of the non-coplanar paths is less than a total number of components included in a shortest one of the coplanar paths, selecting a specific idle processing unit corresponding to the shortest non-coplanar path as one of the one or more target processing units.
